(19) United States
(12) Patent Application Publication
(10) Pub. No.: US 2009/0244091 A1
(43) Pub. Date: Oct. 1, 2009

(54) INFORMATION PROCESSING APPARATUS AND METHOD THEREOF

(75) Inventors: Kenichi HORIO, Kawasaki (JP); Masahiko Murakami, Kawasaki (JP); Ryuichi Matsukura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/406,759

(22) Filed: Mar. 18, 2009

(30) Foreign Application Priority Data
Mar. 31, 2008 (JP) 2008-092243

(51) Int. Cl. G09G 5/00

(52) U.S. Cl. 345/619

(57) ABSTRACT

An information processing apparatus and method includes generating an image to be displayed by a display section, determining, based on a processing capacity of a terminal connected with the information processing apparatus via a communications network or the information processing apparatus itself, a size of an image to be transmitted to the terminal, dividing an image displayed on a screen into a plurality of segments based on the size determined, adding positional information indicating an on-screen position of a segment divided to segment image information based on an image of a segment; and transmitting the segment image information added with the positional information to the terminal via the communications network.

### CROSS-REFERENCE TO RELATED APPLICATIONS

This application is based upon and claims the benefit of priority of the prior Japanese Patent Application No. 2008-92243, filed on Mar. 31, 2008, the entire contents of which are incorporated herein by reference.

### BACKGROUND

1. Field

The embodiment is related to an information processing apparatus and method that transmits a displayed image to a terminal.

2. Description of the Related Art

A remote assistance system now in widespread use features an information processing apparatus such as a personal computer operated by an inexperienced operator and a terminal operated by a skilled person connected to each other via a communications network such as an IP network, where the information processing apparatus is remotely-controlled by the skilled person. In the remote assistance system, by transferring a desktop image displayed by the information processing apparatus to the terminal, the skilled person supports operations performed by the operator while visually confirming image displayed at the information processing apparatus.

Transfer schemes for transferring a displayed image from an information processing apparatus to a terminal can be generally divided into two types, namely, a command transfer method and an image transfer method. The command transfer method refers to a method in which, when displaying a graphic such as a straight line, a quadrangle, or the like, a display command is transferred from the information processing apparatus to a terminal side and a graphic based on the display command is also displayed on the terminal. The image transfer method refers to a method in which a desktop image itself which is displayed on the information processing apparatus is transferred from the information processing apparatus to the terminal and the received image is displayed on the terminal without modification.

The image transfer method has an advantage in that processing by the terminal that assumes the receiver role is relatively simple and is independent of the environment such as an OS of the information processing apparatus that assumes the sender role. However, since an image itself is transferred, a problem of increased transfer data amount exists. To that end, transfer data amount is reduced when transferring an image by performing compression (encoding) on the information processing apparatus-side and expansion (decoding) on the terminal-side. However, depending on the compression method employed, there may be cases where processing load remains high and the entire desktop screen cannot be compressed due to increasingly large screen sizes.

As an attempt to solve such problems, Japanese Patent Laid-Open No. 2001-061066 proposes a method in which a desktop image is divided into a plurality of blocks; whether or not an image is varied is detected for each block, and only images of varied blocks are transmitted.

### SUMMARY

According to an aspect of an embodiment of invention, an information processing apparatus and method include generating an image to be displayed determining, based on a processing capacity of a terminal, a size of an image to be transmitted to the terminal, dividing an image displayed on a screen into a plurality of segments based on the size determined, adding positional information indicating an on-screen position of a segment to segment image information based on an image of a segment divided and transmitting the segment image information added with the positional information to the terminal via a communications network.

The object and advantages of the embodiment of invention will be realized and attained by means of the elements and combinations particularly pointed out in the claims.

It is to be understood that both the foregoing general description and the following detailed description are exemplary and explanatory and are not restrictive of the embodiment of invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an example of a communication system according to an embodiment;

FIG. 2 is a block diagram illustrating an example of hardware of respective devices constituting a communication system according to an embodiment;

FIG. 3 is a functional block diagram illustrating an example of software of respective devices constituting a communication system according to an embodiment;

FIG. 4 is an explanatory diagram schematically illustrating an example of recorded contents of a size determining table provided in an information processing apparatus according to an embodiment;

FIG. 5 is a flowchart illustrating an example of indication information transmission processing executed in a communication system according to an embodiment;

FIG. 6 is a flowchart illustrating an example of image transmission processing executed in a communication system according to an embodiment;

FIG. 7 is a flowchart illustrating an example of image reception processing executed in a communication system according to an embodiment;

FIGS. 8A, 8B and 8C are explanatory diagrams schematically illustrating an example of processing performed by a communication system according to an embodiment;

FIG. 9 is an explanatory diagram schematically illustrating an example of recorded contents of a size determining table provided in an information processing apparatus according an embodiment;

FIG. 10 is a flowchart illustrating an example of image transmission processing executed in a communication system according to an embodiment;

FIG. 11 is a graph illustrating an example of temporal variation in CPU utilization in a communication system according to an embodiment;

FIG. 12 is a flowchart illustrating an example of image transmission processing executed in a communication system according to an embodiment;

FIG. 13 is a graph illustrating an example of temporal variation in CPU utilization in a communication system according to an embodiment;

FIG. 14 is a functional block diagram illustrating an example of software of respective devices constituting a communication system according to an embodiment;

FIG. 15 is a flowchart illustrating an example of feedback processing executed in the communication system according to an embodiment;

FIG. 16 is a flowchart illustrating an example of image transmission processing executed in the communication system according to the fourth embodiment;

FIG. 17 is a flowchart illustrating an example of image transmission processing executed in a communication system according to an embodiment;

FIG. 18 is an explanatory diagram schematically illustrating an example of a segment transmitted during image transmission processing executed in an communication system according to an embodiment,

FIG. 19 is a functional block diagram illustrating an example of software of respective devices constituting a communication system according to an embodiment;

FIG. 20 is an explanatory diagram schematically illustrating an example of recorded contents of an updated segment table included in an information processing apparatus according to an embodiment;

FIG. 21 is a flowchart illustrating an example of update detection processing executed in a communication system according to an embodiment;

FIG. 22 is a flowchart illustrating an example of image transmission processing executed in a communication system according to an embodiment;

FIGS. 23A and 23B are explanatory diagrams schematically illustrating an example of segments transmitted during image transmission processing executed in a communication system according to an embodiment;

FIG. 24 is an explanatory diagram schematically illustrating an example of segments transmitted during image transmission processing executed in a communication system according to an embodiment;

FIG. 25 is a flowchart illustrating an example of image transmission processing executed in a communication system according to an embodiment;

FIG. 26 is a flowchart illustrating an example of image transmission processing executed in a communication system according to an embodiment;

FIGS. 27A and 27B are explanatory diagrams schematically illustrating an example of segments transmitted during image transmission processing executed in a communication system according to an embodiment;

FIG. 28 is a flowchart illustrating an example of image transmission processing executed in a communication system according to an embodiment;

FIG. 29 is an explanatory diagram schematically illustrating an example of segments transmitted during image transmission processing executed in the communication system according to an embodiment;

FIG. 30 is a flowchart illustrating an example of image transmission processing executed in a communication system according to an embodiment;

FIG. 31 is an explanatory diagram schematically illustrating an example of segments transmitted during image transmission processing executed in a communication system according to an embodiment;

FIG. 32 is an explanatory diagram schematically illustrating an example of segments transmitted during image transmission processing executed in a communication system according to an embodiment;

FIG. 33 is a block diagram illustrating an example of hardware of respective devices constituting a communication system according to an embodiment; and

FIG. 34 is a functional block diagram illustrating an example of respective devices constituting the communication system according to an embodiment

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Among others, the technique described in Japanese Patent Laid-Open No. 2001-61066 is disadvantageous in that when a number of varied locations is large, many blocks must be transmitted and processing load increases.

The technique described in Japanese Patent Laid-Open No. 2001-61066 is also disadvantageous in that the processing load for detecting whether or not a variation has occurred is significant.

The technique described in Japanese Patent Laid-Open No. 2001-61066 is further disadvantageous in that depending on the terminal-side processing capacity, an appropriate block size is not necessarily obtained.

The present invention, for example ensures that a size of a transmitted block is appropriate by determining a block size based on a processing capacity of an information processing apparatus and/or a terminal.

In addition, by transmitting, from the information processing apparatus to the terminal, a block of an image at a position determined based on the position of an indicating section that indicates an on-screen position at the terminal, it is now possible to control processing load due to the transmission of a block regardless of a variation status, and processing for detecting the existence/nonexistence of variations becomes unnecessary.

An embodiment of the present invention discloses an apparatus or the like including a display unit that causes an image to be displayed on a screen, a size determining section that determines, based on a processing capacity of a terminal connected via a communications network or a processing capacity of the apparatus, a size of an image to be transmitted to the terminal, a dividing section that divides an image displayed on the screen into a plurality of segments based on the size determined by the size determining section, a positional information adding section that adds positional information indicating a position of a segment on the screen to segment image information based on an image of a segment divided by the dividing section, and a communicating section that transmits the segment image information added with the positional information to the terminal via the communications network.

An embodiment of the present invention ensures that the size of an image to be transmitted to the terminal is appropriate by determining the image size based on the processing capacity of the information processing apparatus. Moreover, in an embodiment of the present invention, by determining a block of an image to be transmitted based on a position indicated by indication information, the block to be transmitted is determined regardless of a status of the image such as whether or not the image has been varied or the position or the size of the image.

An information processing apparatus according to an embodiment of the present invention, for example, ensures that a processing load due to image transmission is appropriate by determining a size of an image to be transmitted to a terminal based on a processing capacity of the information processing apparatus so that the image size becomes appropriate.

Furthermore, since the information processing apparatus and the like disclosed in the present invention determines a block of an image to be transmitted based on a position indicated by indication information in order to determine a block to be transmitted regardless of a status of the image such as whether or not the image has been varied, the position or size of the image, it is now possible to control processing load due to the transmission of a block, and processing for detecting whether or not the image has been varied becomes unnecessary.

Hereinafter, a detailed description will be given with reference to drawings representing embodiments.

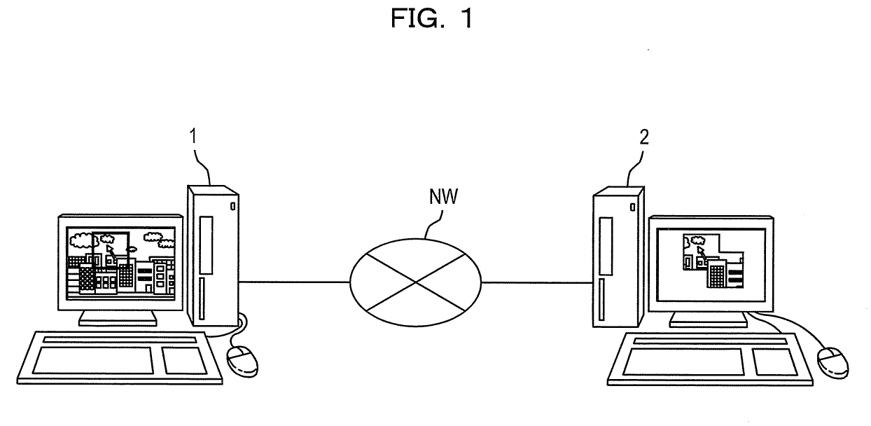

FIG. 1 is a diagram illustrating an example of a communication system according to an embodiment. In FIG. 1, reference numeral 1 denotes an information processing apparatus such as a terminal computer. The information processing apparatus 1 is connected to a communications network NW such as a LAN, a WAN, a VPN, the Internet, etc. A terminal 2 for which is used a computer such as a terminal computer is connected to the communications network NW. The information processing apparatus 1 and the terminal 2 communicate via the communications network NW.

In an embodiment of the present invention, it is assumed that, for example, the information processing apparatus 1 is operated by an inexperienced operator and the terminal 2 by a skilled person. The skilled person remotely operates the information processing apparatus 1 via the terminal 2 to realize a remote assistance system. In a remote assistance system, by transmitting a desktop image displayed at the information processing apparatus 1 to the terminal 2, the skilled person may support operations performed by the operator while visually confirming an image displayed at the information processing apparatus 1.

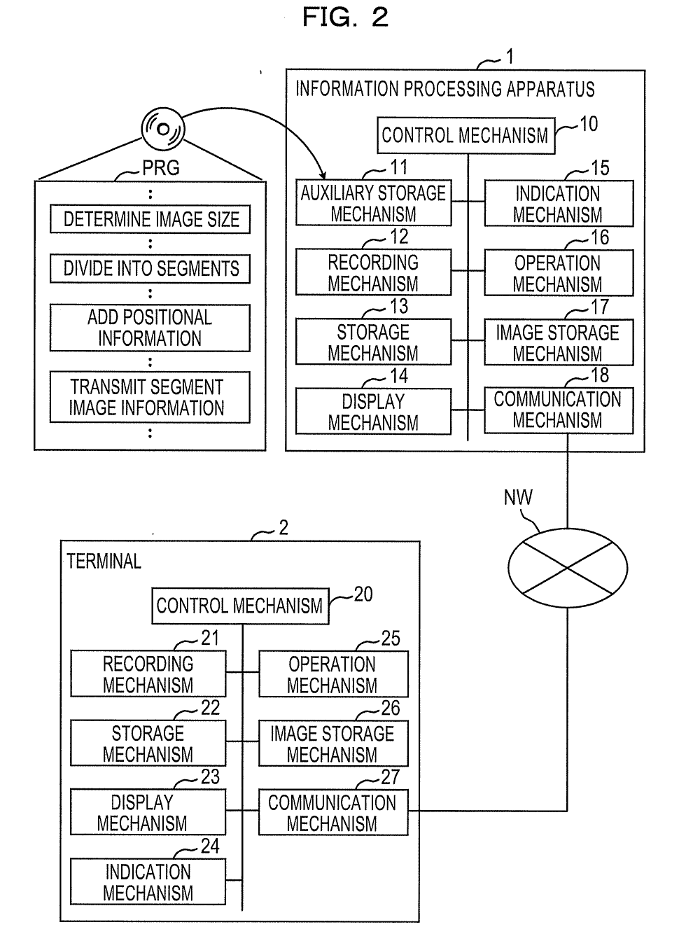

FIG. 2 is a block diagram illustrating an example of hardware of respective devices constituting a communication system according to an embodiment. The information processing apparatus 1 includes a control mechanism 10, an auxiliary storage mechanism 11, a recording mechanism 12, and a storage mechanism 13. The control mechanism 10 controls the entire apparatus. The control mechanism 10 is a CPU or the like. The auxiliary storage mechanism 11 storing various information such as a computer program (PRG), data, and the like and reads out various information from a recording medium such as a CD-ROM. The auxiliary storage mechanism 11 may be a CD-ROM drive or the like. The recording medium to be read by the auxiliary storage mechanism 11 stores various information such as a computer program PRG, data, and the like which may be implemented to realize an aspect of the present invention. The recording mechanism 12 records various information read by the auxiliary storage mechanism 11. The recording mechanism 12 may be a hard disk or the like. The storage mechanism 13 temporarily stores information. The storage mechanism 13 is a RAM or the like.

A terminal computer operates as the information processing apparatus 1 according to an embodiment of the present invention by causing the computer program (PRG) stored in the recording mechanism 12 and which realizes an embodiment of the present invention be stored by the storage mechanism 13 and executed under the control by the control mechanism 10. The information processing apparatus 1 includes a display mechanism 14, an indication mechanism 15, an operation mechanism 16, an image storage mechanism 17, and a communication mechanism 18. The display mechanism 14 is a monitor or the like. The indication mechanism 15 indicates a position on an image to be displayed by the display mechanism 14. The indication mechanism 15 is a mouse, a trackpad or the like. The operation mechanism 16 is a keyboard or the like. The image storage mechanism 17 stores an image to be displayed by the display mechanism 14. The image storage mechanism 17 is a VRAM or the like. The communication mechanism 18 connects to the communications network NW. The communication mechanism 18 is a LAN port or the like. Moreover, in addition to the computer program PRG that realizes the present invention, the recording mechanism 12 stores various programs including a basic program (OS or Operating System).

The terminal 2 includes various mechanisms such as a control mechanism 20, a recording mechanism 21, a storage mechanism 22, a display mechanism 23, an indication mechanism 24, an operation mechanism 25, an image storage mechanism 26, and a communication mechanism 27. While the information processing apparatus 1 and the terminal 2 are illustrated in FIG. 2 using particular mechanisms, the present invention is not limited thereto. For example, any or part of the mechanisms illustrated in FIG. 2 may be implemented using one or more hardware or software components.

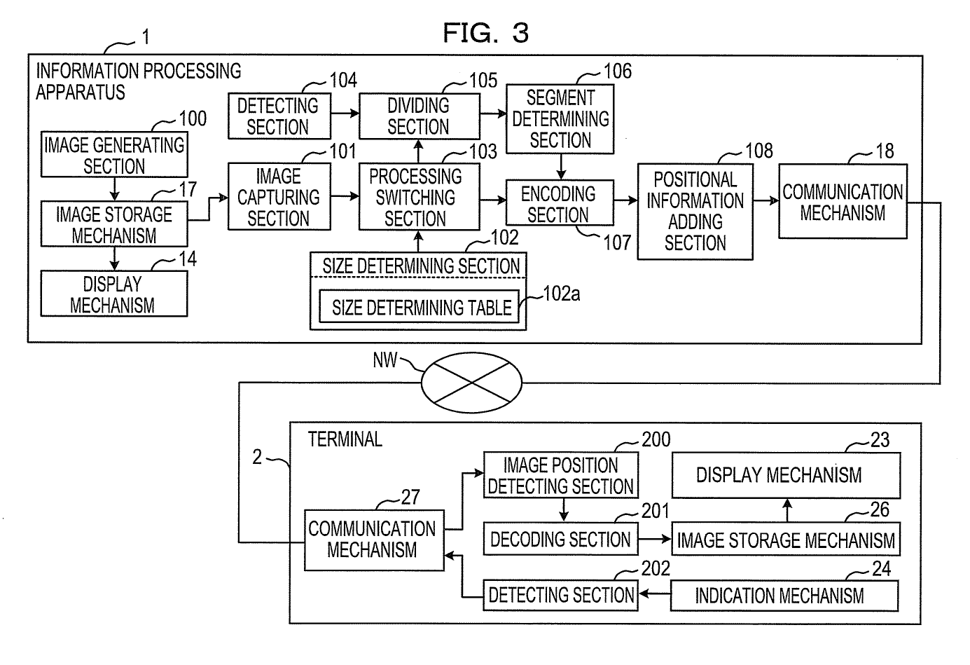

FIG. 3 is a functional block diagram illustrating an example of software of respective devices constituting a communication system according to an embodiment. The information processing apparatus 1 executes the computer program PRG with the control mechanism 10. The information processing apparatus 1 realizes a variety of functions as various program modules including those implemented via an image generating section 100, an image capturing section 101, a size determining section 102, a processing switching section 103, a detecting section 104, a dividing section 105, a segment determining section 106, an encoding section 107, and a positional information adding section 108.

The image generating section 100 functions to generate an image to be displayed by the display mechanism 14 based on various control instruction(s) regarding image rendering and to cause the image storage mechanism 17 to store the generated image. The image capturing section 101 functions to capture an image stored in the image storage mechanism 17. The size determining section 102 functions to determine the size of an image to be transmitted to the terminal 2 based on recorded contents of a size determining table 102a. The processing switching section 103 functions to switch processing depending on the size of an image to be transmitted to the terminal 2. The detecting section 104 functions to detect a position on an image indicated by the indication mechanism 24 of the terminal 2. The dividing section 105 functions to divide an image into a plurality of segments. The segment determining section 106 functions to determine a segment of an image to be transmitted among a plurality of segments. The encoding section 107 functions to encode an image to be transmitted. The positional information adding section 108 functions to add positional information such as the position of a segment of an image to be transmitted.

The terminal 2 realizes a variety of functions as various program modules including those implemented via an image position detecting section 200 that detects the position of a received image based on added positional information, a decoding section 201 that decodes an encoded image, and a detecting section 202 that detects a position on an image indicated by the indication mechanism 24.

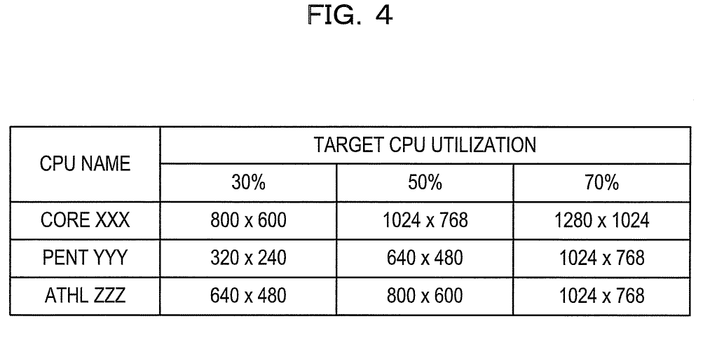

FIG. 4 is an explanatory diagram schematically illustrating an example of recorded contents of the size determining table 102a provided in the information processing apparatus 1 according to an embodiment. The size determining table 102a associates CPU names with target CPU utilizations and records image sizes corresponding to the CPU names and the target CPU utilizations. A CPU name refers to a name indicating, for example, a CPU type as an index regarding the processing capacity of the information processing apparatus 1, and is acquired from the control mechanism 10 mounted in the information processing apparatus 1. A target CPU utilization is determined by reading a utilization set in advance in the recording mechanism 12. An image size refers to the size of a segment when dividing the screen at the dividing section 105. Moreover, an index regarding processing capacity is not necessarily limited to a CPU name, and various indexes including a storage capacity of a RAM that is one example of the storage mechanism 13 can be used as long as such indexes indicate the processing capacity of the information processing apparatus 1. In addition, while FIG. 4 illustrates a size determining table 102a used when transmitting an image at a frame rate of, for example, 30 fps, a different size determining table 102a may be arranged to be used for each different frame rate such as 60 fps, 15 fps and the like.

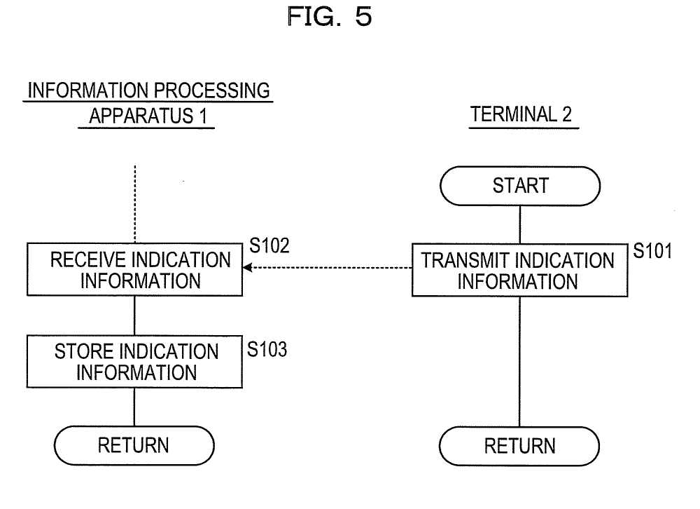

Next, processing performed by the respective devices according to an embodiment is described. FIG. 5 is a flowchart illustrating an example of indication information transmission processing executed in a communication system according to an embodiment. A skilled person operates the indication mechanism 24 of the terminal 2 to indicate an arbitrary position on a screen displayed on the display mechanism 23 using an indicator such as a mouse pointer or a cursor. Under the control by the control mechanism 20, the terminal 2 accepts the operation of the indication mechanism 24 and transmits indication information indicating an on-screen position indicated by the indicator from the communication mechanism 27 to the information processing apparatus 1 via the communications network NW (S101). The transmission in operation S101 is executed at a time interval set as the frame rate. The indication information may be information such as coordinates that indicate a relative position as a difference from a previous position or information such as coordinates that indicate an absolute position on the screen. When a relative position is to be used as indication information, such an indicated position may be arranged to be transmitted when a variation occurs in the position of the indicator occurs instead of at a regular time interval.

Under the control of the control mechanism 10 executing the computer program PRG, for example, the information processing apparatus 1 receives indication information at the communication mechanism 18 (S102) and stores the received indication information in the storage mechanism 13 (S103). Depending on the mode of the remote assistance system being executed, the information processing apparatus 1 detects a position indicated by the indication information stored in the storage mechanism 13 using the detecting section 104, outputs a control instruction for rendering the indicator to the image generating section 100, and executes processing such as generating an image of the indicator rendered at an on-screen position corresponding to the detected position using the image generating section. As illustrated, the indication information transmission processing according to an embodiment is executed.

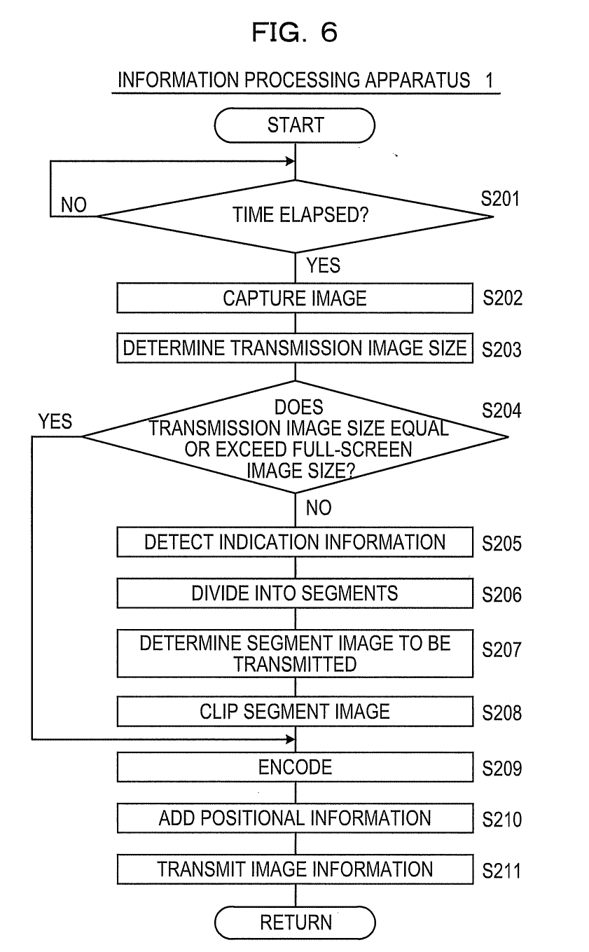

FIG. 6 is a flowchart illustrating an example of image transmission processing executed in a communication system according to an embodiment. Based on control by the control mechanism 10 executing the computer program PRG, the information processing apparatus 1 references a time measured by a timekeeping section such as a clock built into the control mechanism 10 to judge whether or not a given period of time indicated by the set image transmission interval has elapsed since a previous transmission of the image (S201). For example, at a frame rate of 30 fps, the image transmission interval is 1/30 seconds.

In operation S201, when it is judged that the given period of time has elapsed (S201: YES), under the control of the control mechanism 10, the information processing apparatus 1 captures the image generated by the image generating section 100, stored in the image storage mechanism 17 and to be displayed by the display mechanism 14 using the image capturing section 101 (S202).

In operation S201, when it is judged that a given period of time has not elapsed (S201: NO), due to the control of the control mechanism 10, the information processing apparatus 1 repeats the processing of operation S201.

After capturing the image in operation S202, through processing performed by the size determining section 102 under the control of the control mechanism 10, the information processing apparatus 1 references the size determining table 102a to determine the size of an image to be transmitted to the terminal 2 based on a name of a CPU used by the control mechanism 10 which indicates the processing capacity of the apparatus itself and a preset target CPU utilization (S203). The determination of the image size in operation S203 may be made by reading an image size determined in advance.

Through processing performed by the processing switching section 103 under the control of the control mechanism 10, the information processing apparatus 1 judges whether or not the size of the image to be transmitted determined in operation S203 is equal to or greater than a size of a full-screen image displayed by the display mechanism 14 or, in other words, the size of a so-called desktop screen (S204).

In operation S204, when it is judged that the size of the transmission image is smaller than the desktop screen size (S204: NO), through processing performed by the detecting section 104 under the control of the control mechanism 10, the information processing apparatus 1 detects indication information of the terminal 2 received in operation S102 and stored in operation S103 of the indication information transmission processing (S205).

Through processing performed by the dividing section 105 under the control of the control mechanism 10, the information processing apparatus 1 divides the full-screen image displayed by the display mechanism 14 into a plurality of segments based on the image size determined by the size determining section 102 (S206). Information on the image displayed by the display mechanism 14 can be read from the image generating section 100. The size of the respective segments divided in operation S206 is based on the image size determined by the size determining section 102. The division in operation S206 may be performed using either the screen or a position indicated by the indication information as reference.

Through processing of the segment determining section 106 under the control of the control mechanism 10, the information processing apparatus 1 determines an image of a segment to be transmitted to the terminal 2 among the plurality of segments (S207). In operation S207, a segment including the position indicated by the indication information is determined as the segment to be transmitted.

Through processing performed by the image capturing section 101 under the control of the control mechanism 10, the information processing apparatus 1 clips a segment image that is an image of the determined segment from the image captured in operation S202 (S208), and encodes segment image information indicating the clipped segment image using a given encoding method through processing performed by the encoding section 107 (S209). In operation S209, encoding under an encoding method suitable for video streaming such as MPEG4 (Motion Picture Expert Group 4) is performed.

Subsequently, due to processing performed by the positional information adding section 108 under the control of the control mechanism 10, positional information indicating an on-screen position of the segment is added to encoded segment image information (S210), and the positional information-added segment image information is transmitted from the communication mechanism 18 to the terminal 2 via the communications network NW (S211). When the segment is, for example, rectangular, information indicating coordinates of respective vertices becomes the positional information in operation S211. In operation S211,transmission is performed under a communication method defined by a communication protocol appropriate for video streaming such as RTP (Real-time Transport Protocol).

In operation S204, when it is judged that the size of the transmission image is equal to or greater than the size of the desktop image (S204: YES), the information processing apparatus 1 proceeds to operation S209 to execute processing for encoding, addition of positional information, and transmission. In this case, in operation S209, full-screen image information indicating a full-screen image is encoded, and in operation S210, information indicating that the encoded image information is full-screen image information is added. Moreover, instead of transmitting an image at regular time intervals, an image may be arranged to be transmitted when a variation occurs in the position indicated by the indication information or, in other words, when the indication mechanism 24 that is a mouse or the like is operated at the terminal 2 side. As illustrated, the image transmission processing according to an embodiment is executed.

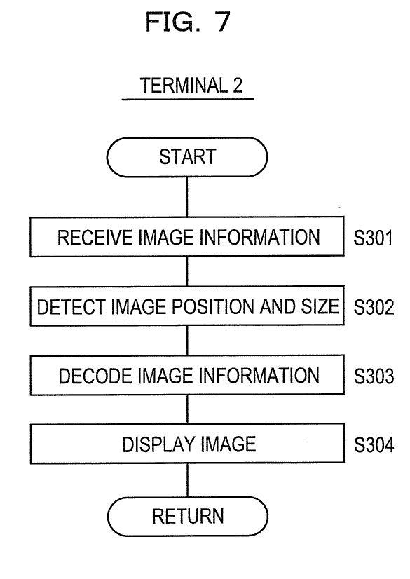

FIG. 7 is a flowchart illustrating an example of image reception processing executed in a communication system according to an embodiment. Based on the control by the control mechanism 20, the terminal 2 receives image information from the communication mechanism 27 transmitted via the communications network NW including positional information-added segment image information, full-screen image information, and the like (S301).

Through processing of the image position detecting section 200 based on the control by the control mechanism 20, the terminal 2 determines a position and size of an image based on positional information added to image information (S302).

Due to processing performed by the decoding section 201 based on the control by the control mechanism 20, the terminal 2 decodes the encoded image information (S303).

Subsequently, due to control by the control mechanism 20, the terminal 2 displays the decoded image on the display mechanism 23 based on the detected position and size (S304). At this point, when a different image is already being displayed at the position where the decoded image should be displayed, the displayed image is to be updated with the decoded image. As illustrated, the image reception processing according to an embodiment is executed.

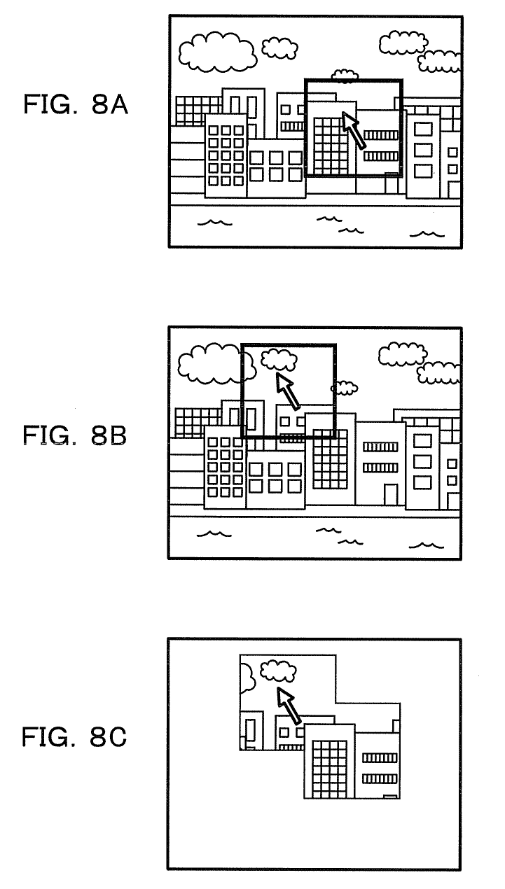

FIG. 8 is an explanatory diagram schematically illustrating an example of processing performed in a communication system according to an embodiment. FIGS. 8A and 8B illustrate an image displayed on the display mechanism 14 of the information processing apparatus 1. In the image, the indicator (mouse pointer) is displayed at positions based on indication information received from the terminal 2. In addition, the rectangles defined by the bold lines in the drawings indicate divided image segments divided based on the positions of the indicator. In other words, the drawings illustrate a situation where the information processing apparatus 1 is operated from the terminal 2 side in the remote assistance system mode. Assume now that due to an operation by the skilled person operating the terminal 2, the image displayed on the display mechanism 14 of the information processing apparatus 1 has changed from FIG. 8A to FIG. 8B. In other words, this is a situation where the operation by the skilled person has caused the position of the mouse point to move towards the upper left in the screen.

FIG. 8C illustrates an image displayed on the display mechanism 23 of the terminal 2. The display mechanism 23 of the terminal 2 displays an image of a divided image segment corresponding to the status illustrated in FIG. 8A and an image of a divided image segment corresponding to the status illustrated in FIG. 8B which is displayed as a result of the movement of the mouse pointer. As illustrated, with the communication system according to an embodiment, by having the skilled person move the indicator to a desired position, the image of the information processing apparatus 1 corresponding to the position of the indicator is displayed on the screen of the display mechanism 14 of the terminal 2.

While an embodiment in which an image size is determined at the stage of operation S203 of image transmission processing has been illustrated for an embodiment described above, the image size may alternatively be determined and set in advance after a transition is made to the remote assistance system mode, communication has been established between the terminal 2, and the like, but before commencing image transmission processing. When determining the image size in advance before image transmission processing commences, for example, an encoding test involving encoding a pre-recorded sample image by the encoding section 107 may be performed to determine the image size based on factors such as the result of the encoding test, required encoding time, CPU utilization during encoding, and the like. Specifically, when encoding is performed at a CPU utilization of 50% or less, a determination method is executed involving, for example, determining a size encodable within a given period of time is determined as the image size.

An embodiment involves dynamically varying the size of an image to be transmitted. Functions similar to those of the above-described embodiment shall be denoted by similar reference characters and detailed descriptions shall be omitted. Since examples of a communication system as well as hardware and software of the respective devices according to an embodiment are similar to those of the above-described embodiment, descriptions thereof shall be omitted. However, recorded contents of a size determining table 102a of an information processing apparatus 1 according to an embodiment differs from that of the above-described embodiment.

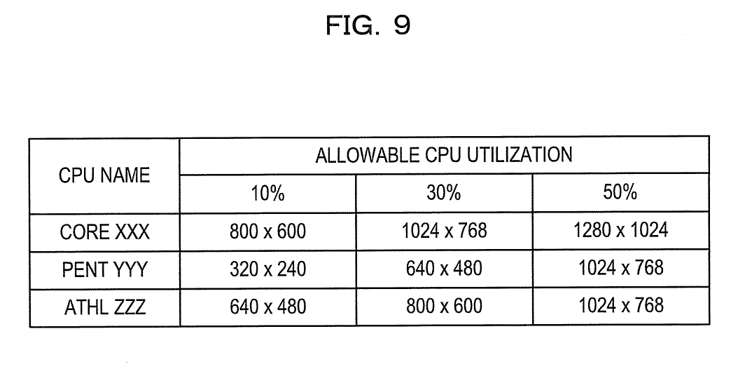

FIG. 9 is an explanatory diagram schematically illustrating an example of recorded contents of the size determining table 102a provided in the information processing apparatus 1 according to an embodiment. The size determining table 102a according to an embodiment associates CPU names with allowable CPU utilizations and stores image sizes corresponding to the CPU names and the allowable CPU utilizations. An allowable CPU utilization is a value obtained by subtracting a detected CPU utilization from an upper limit CPU utilization set in advance. For example, when the upper limit CPU utilization is set to 70%, the CPU utilization at that point is detected, whereby a detected CPU utilization of 20% results in an allowable CPU utilization of 50%. In other words, this is a method in which an operational status of a CPU is detected to inhibit CPU processing load to or below an upper limit CPU utilization. Since the operational status of a CPU varies, in an embodiment, an image size determined based on a CPU name and an allowable CPU utilization varies dynamically. While image transmission processing is to be executed at 1/30-second intervals corresponding to the frame rate, performing size determination processing every time image transmission processing is executed increases processing load. In addition, when variations in the CPU are abrupt, there is a problem in that the size of the image to be transmitted cannot be stabilized. In consideration thereof, it is desirable to calculate an average CPU utilization over a given period of time such as 10 seconds, and based on the calculated average CPU utilization, fix the image size during the given period of time of 10 seconds. In this case, the image size is to be updated every 300 frames. In addition, while FIG. 9 illustrates a size determining table 102a used when transmitting an image at a frame rate of, for example, 30 fps, a different size determining table 102a may be arranged to be used for each different frame rate such as 60 fps, 15 fps and the like.

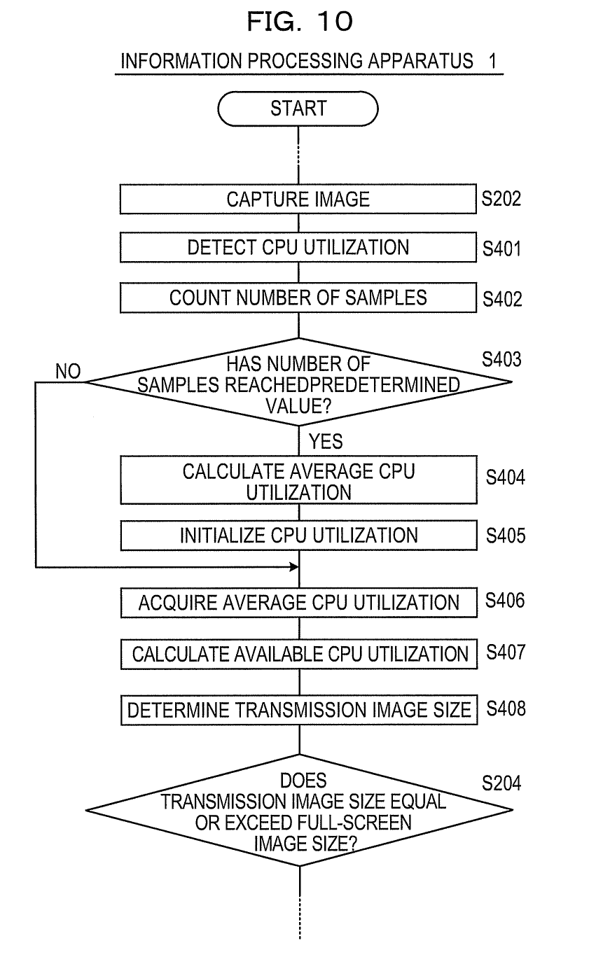

Next, processing performed by the respective devices according to an embodiment is described. This embodiment differs from the above-identified embodiment with respect to image transmission processing. FIG. 10 is a flowchart illustrating an example of image transmission processing executed in the communication system according to an embodiment. In the image transmission processing according to an embodiment, an image size is dynamically varied based on an average CPU utilization. However, until the average CPU utilization is calculated for the first time, an initial value such as 320×240 may be to be used. The image transmission processing according to an embodiment differs from that of the above-identified embodiment in the processing of operation S203 of the image transmission processing according to the above-identified embodiment described earlier with reference to FIG. 6. The information processing apparatus 1 executes processing of operations S201 and S202 of the image transmission processing according to the above-identified embodiment described earlier with reference to FIG. 6.

Through processing performed by a size determining section 102 under the control of a control mechanism 10 executing a computer program PRG, the information processing apparatus 1 detects the utilization of a CPU used by the control mechanism 10 (S401), and stores the detected utilization value in the storage mechanism 13.

Through processing performed by the size determining section 102 under the control of the control mechanism 10, the information processing apparatus 1 counts a number of samples of measured CPU utilizations stored in a storage mechanism 13 (S402), and judges whether or not the number of counted samples have reached a threshold (S403). When the frame rate is 30 fps and CPU utilization is to be averaged over 10 seconds, a threshold of 300 is to be used in operation S403.

In operation S403, when it is judged that the number of samples has reached the threshold (S403: YES), through processing performed by the size determining section 102 under the control of the control mechanism 10, the information processing apparatus 1 calculates an average value of the number (for example, 300) of CPU utilizations stored in the storage mechanism 13 (S404), stores the calculated average CPU utilization in the storage mechanism 13, and initializes the CPU utilization stored in the storage mechanism 13 (S405). The initialization of operation S405 erases the values of the 300 stored CPU utilizations. In addition, the initialization of operation S405 also initializes the number of samples of CPU utilizations.

In operation S403, when it is judged that a number of samples has not reached the threshold (S403: NO), the processing of operations S404 and S405 is not executed.

Subsequently, through processing performed by the size determining section 102 under the control of the control mechanism 10, the information processing apparatus 1 acquires a most recently-calculated average CPU utilization stored in the storage mechanism 13 (S406), and calculates an available CPU utilization by subtracting the average CPU utilization acquired in operation S406 from the upper limit CPU utilization set in advance (S407).

Due to processing performed by the size determining section 102 under the control of the control mechanism 10, the information processing apparatus 1 references the size determining table 102a in order to determine the size of an image to be transmitted to the terminal 2 based on the name of a CPU used by the control mechanism 10 which indicates the processing capacity of the apparatus itself and the calculated available CPU utilization (S408). When an allowable CPU utilization matching the available CPU utilization calculated in operation S407 has not been set in the size determining table 102a, the image size is to be determined based on a value nearest to the available CPU utilization among allowable CPU utilizations set in the size determining table 102a or on an allowable CPU utilization having the smallest value among those greater than the available CPU utilization.

Subsequently, the information processing apparatus 1 executes processing of operation S204 and thereafter of the image transmission processing according to the above-described embodiment described earlier with reference to FIG. 6. As illustrated, the image transmission processing according to an embodiment is executed.

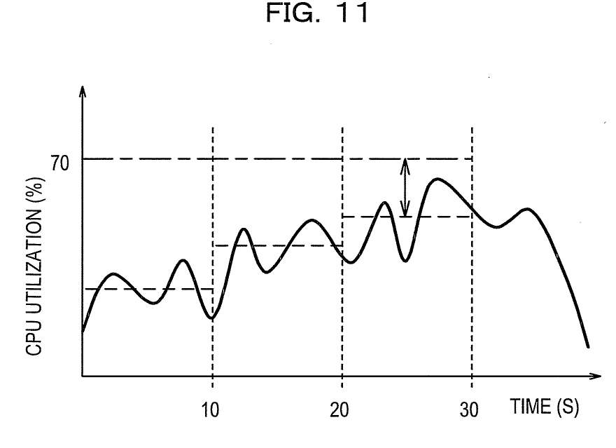

FIG. 11 is a graph illustrating an example of temporal variation in CPU utilization in the communication system according to an embodiment. In FIG. 11, a relationship between time and CPU utilization is illustrated using time as the abscissa and CPU utilization as the ordinate. In FIG. 11, the solid line indicates CPU utilization, the dashed-dotted line indicates a preset upper limit CPU utilization, and the dotted line indicates average CPU utilizations. As illustrated in FIG. 11, the average CPU utilization is updated every 10 seconds. Furthermore, in FIG. 11, the difference between the upper limit CPU utilization and the average CPU utilization denoted by the two-headed arrow indicates available CPU utilization and is associated with the allowable CPU utilization stored in the size determining table 102a. The period of time over which CPU utilization is to be averaged need not be limited to 10 seconds and can be set appropriately or be arranged to vary dynamically. The longer the period of time over which CPU utilization is to be averaged, the more stable image size becomes, thereby preventing variations among images per frame from increasing. As a result, encoding efficiency is enhanced. In addition, the shorter the period of time, the more accurately instantaneous increases in CPU utilization are followed. As a result, backlog of transmission processing during a temporary increase in processing load can be prevented. As illustrated, by dynamically varying the image size depending on CPU utilization, CPU capacity can now be utilized efficiently.

An embodiment involves dynamically varying the size of an image to be transmitted without using the size determining table used in the above-identified embodiment. Functions similar to those of the embodiments discussed above shall be denoted by similar reference characters and detailed descriptions shall be omitted. Since examples of a communication system as well as hardware and software of the respective devices according to an embodiment are similar to those of the first embodiment, descriptions thereof shall be omitted. However, an information processing apparatus 1 according to an embodiment does not require the size determining table 102a.

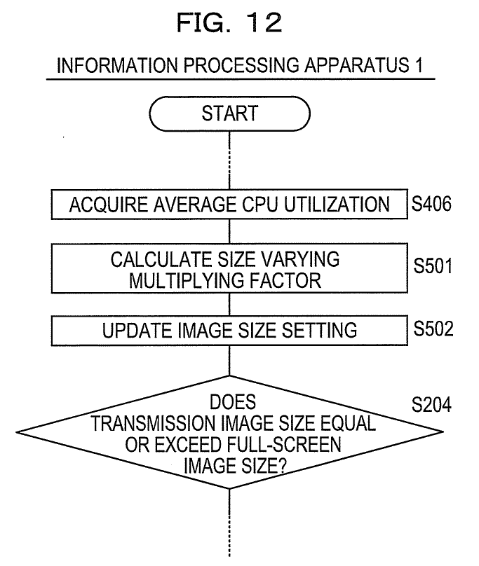

Next, processing performed by the respective devices according to an embodiment is described. An embodiment differs from the above discussed embodiments with respect to image transmission processing. FIG. 12 is a flowchart illustrating an example of image transmission processing executed in a communication system according to an embodiment. In the image transmission processing according to an embodiment, while an image size is dynamically varied based on an average CPU utilization, until an average CPU utilization is calculated for the first time, an initial value such as 320×240 is to be used. The image transmission processing according to an embodiment differs from that of the first embodiment in the processing of operation S203 of the image transmission processing according to the above-identified embodiment described with reference to FIG. 6. An information processing apparatus 1 executes processing of operations S201 and S202 of the image transmission processing according to the first embodiment described earlier with reference to FIG. 6. Furthermore, the information processing apparatus 1 executes processing of operations S401 to S406 of the image transmission processing according to an embodiment described earlier with reference to FIG. 10.

Through processing performed by a size determining section 102 under the control of a control mechanism 10 executing a computer program PRG, the information processing apparatus 1 calculates a size varying multiplying factor by dividing an acquired average CPU utilization by a target CPU utilization (S501). A target CPU utilization is a CPU utilization target value such as 50% or 70%. A set value thereof is stored in advance in, for example, the recording mechanism 12 or the storage mechanism 13. For example, when the target CPU utilization is 70% and the acquired average CPU utilization is 30%, the size varying multiplying factor is 70/30≈2.33.

Through processing of the size determining section 102 under the control of the control mechanism 10, the information processing apparatus 1 updates the image size setting by multiplying the set image size by the calculated size varying multiplying factor (S502). The size varying multiplying factor calculated in operation S501 is a multiplying factor with respect to area. Therefore, longitudinal and lateral lengths (number of dots) are to be multiplied by a square root of the size varying multiplying factor. Moreover, while operation S502 may be arranged so that an updated image size is obtained by multiplying the image size with the size varying multiplying factor, a plurality of sizes such as 800×600 and 1024×768 may be set in advance as options, whereby an image size nearest to a value obtained by multiplying by the size varying multiplying factor or the greatest value among values smaller than the value obtained by multiplying by the size varying multiplying factor may be set as the updated image size.

Subsequently, the information processing apparatus 1 executes processing of operation S204 and thereafter of the image transmission processing according to the above identified embodiment described earlier with reference to FIG. 6. As illustrated, the image transmission processing according to an embodiment is executed.

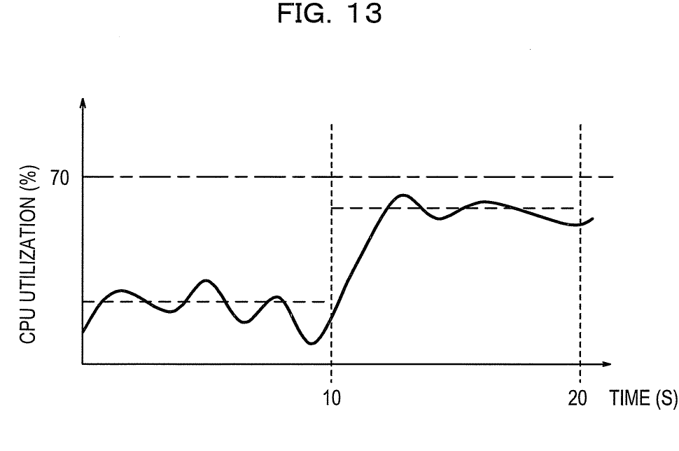

FIG. 13 is a graph illustrating an example of temporal variation in CPU utilization in the communication system according to an embodiment. In FIG. 13, a relationship between time and CPU utilization is illustrated using time as the abscissa and CPU utilization as the ordinate. In FIG. 13, the solid line indicates CPU utilization, the dashed-dotted line indicates a target CPU utilization, and the dotted line indicates average CPU utilizations. As illustrated in FIG. 13, since an image size is to be determined based on the ratio between target CPU utilization and average CPU utilization, average CPU utilization takes a value equivalent to or near target CPU utilization. When dynamically varying the image size in this manner, the size determining table 102a becomes unnecessary.

An embodiment involves an information processing apparatus according to the above-identified embodiment dynamically varying image size based on feedback from a terminal. Functions similar to those of the above identified embodiments shall be denoted by similar reference characters and detailed descriptions shall be omitted. Since examples of a communication system as well as hardware of the respective devices according to an embodiment are similar to those of the first embodiment, descriptions thereof shall be omitted.

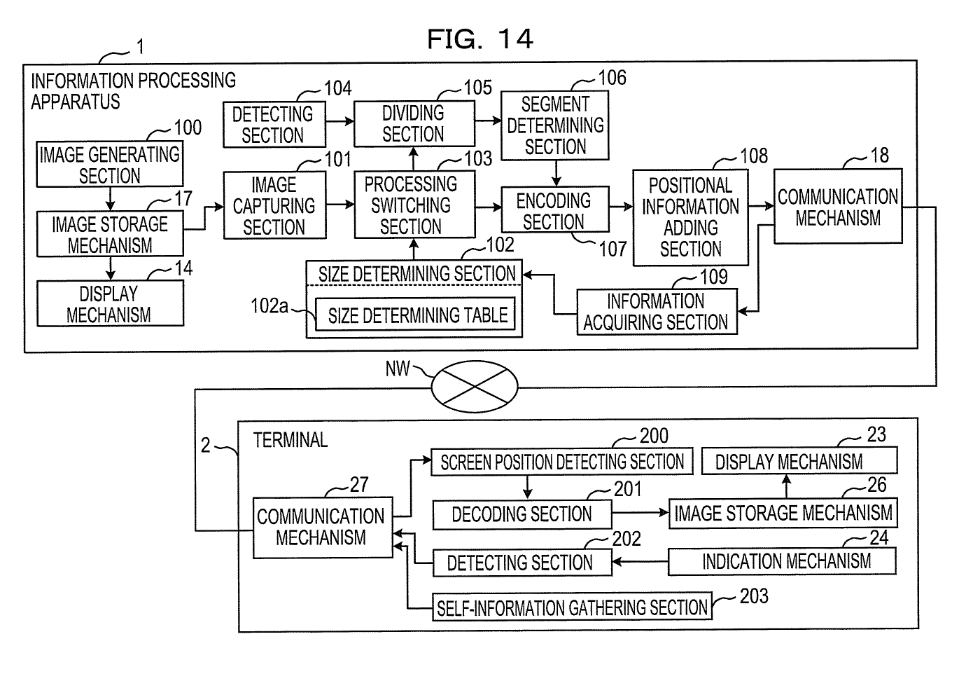

FIG. 14 is a functional block diagram illustrating an example of software of respective devices constituting the communication system according to an embodiment. An information processing apparatus 1 realizes a variety of functions as various program modules including an image generating section 100, an image capturing section 101, a size determining section 102 having a size determining table 102a, a processing switching section 103, a detecting section 104, a dividing section 105, a segment determining section 106, an encoding section 107, a positional information adding section 108, and an information acquiring section 109 that acquires feedback information received from a terminal 2.

The terminal 2 realizes a variety of functions as various program modules including a image position detecting section 200, a decoding section 201, a detecting section 202, and a self-information gathering section 203, which gathers information regarding itself.

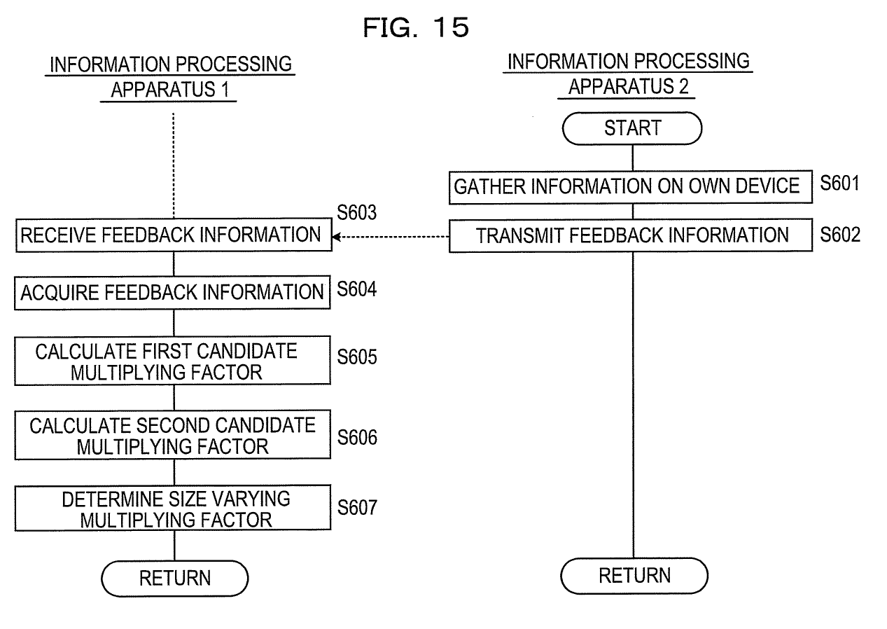

Next, processing performed by the respective devices according to an embodiment is described. In an embodiment, feedback processing is executed concurrently with the processing performed in the above identified embodiments. FIG. 15 is a flowchart illustrating an example of feedback processing executed in the communication system according to an embodiment. Due to processing performed by the self-information gathering section 203 under the control of a control mechanism 10, the terminal 2 gathers information regarding itself (S601), and transmits the gathered information as feedback information to the information processing apparatus 1 from the communication mechanism 27 via the communications network NW (S602). Information regarding itself gathered in operation S601 refers to information such as a CPU utilization of the device itself and a packet loss rate. A CPU utilization of the device itself is a value obtained by detecting CPU utilization of the control mechanism 10 of the device itself and averaging the detected CPU utilization over a given period of time. A packet loss rate refers to a rate at which packets included in image information received from the information processing apparatus 1 is lost over a given period of time. The transmission in operation S602 is executed at, for example, a given time interval.

Under the control of the control mechanism 10 executing a computer program PRG, the information processing apparatus 1 receives feedback information including information such as CPU utilization of the terminal 2, packet loss rate, and the like at the communication mechanism 18 (S603), and acquires the received feedback information through processing performed by the information acquiring section 109 (S604). The acquisition of feedback information in operation S604 refers to processing for, for example, storing received feedback information in the storage mechanism 13. Feedback information stored in the storage mechanism 13 is to be used as appropriate. When previous feedback information is already stored in the storage mechanism 13, such feedback information is updated by newly-received feedback information.

Through processing performed by the size determining section 102 under the control of the control mechanism 10, with a calculation formula using the CPU utilization of the terminal 2 included in the acquired feedback information, the information processing apparatus 1 calculates a first candidate multiplying factor to be used as a multiplying factor candidate for varying the size of an image to be transmitted (S605). In operation S605, the first candidate multiplying factor is calculated using Formula (1) below.

First candidate multiplying factor=Constant−CPU utilization Formula (1)

In Formula (1), the constant is a value such as 1.5 which can be appropriately set. In order to avoid an increase in processing load due to image size enlargement, an upper limit such as 1 may be set to the first candidate multiplying factor. That is, when a calculation of Formula (1) results in a value of less than 1, the value is taken as the first varying multiplying factor, and when the calculation results in a value of 1 or greater, 1 is taken as the first candidate multiplying factor.

Through processing performed by the size determining section 102 under the control of the control mechanism 10, with a calculation formula using the packet loss rate included in the acquired feedback information, the information processing apparatus 1 calculates a second candidate multiplying factor to be used as a multiplying factor candidate for varying the size of an image to be transmitted (S606). In operation S606, the second candidate multiplying factor is calculated using Formula (2) below.

Second candidate multiplying factor=1−Loss rate Formula (2)

Subsequently, through processing of the size determining section 102 under the control of the control mechanism 10, the information processing apparatus 1 determines a size varying multiplying factor from the calculated first and second candidate multiplying factors (S607). In operation S607, a size varying multiplying factor is determined by selecting whichever is smaller of the first and second candidate multiplying factors. For example, when the first candidate multiplying factor is 1.00 and the second candidate multiplying factor is 0.99, the size varying multiplying factor is determined to be 0.99. Moreover, variables, calculation formulas and the like to be used as feedback information are not limited to the examples described above and can be arbitrarily set. As illustrated, the feedback processing according to an embodiment is executed.

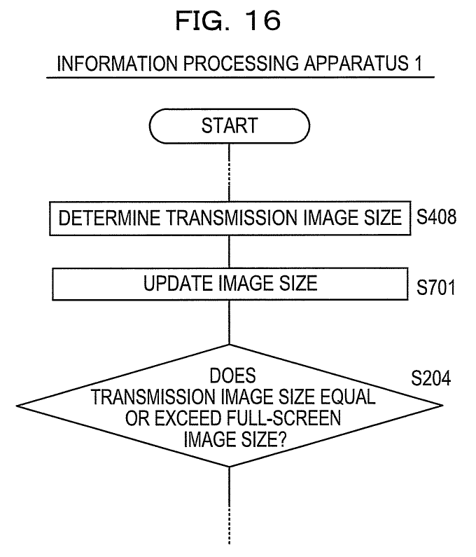

Image transmission processing according to an embodiment involves adding calculation processing based on the size varying multiplying factor calculated by the feedback processing to the image transmission processing according to the above identified embodiment. FIG. 16 is a flowchart illustrating an example of image transmission processing executed in the communication system according to an embodiment. The information processing apparatus 1 executes processing of operations S201 and S202 of the image transmission processing according to the first embodiment described earlier with reference to FIG. 6, and then executes processing of operations S401 to S408 of the image transmission processing according to the embodiment described earlier with reference to FIG. 10.

Through processing of the size determining section 102 under the control of the control mechanism 10 that executes a computer program PRG, the information processing apparatus 1 updates an image size by multiplying the image size determined in operation S408 by the size varying multiplying factor determined through the feedback processing (S701). The size varying multiplying factor calculated in operation S408 is a multiplying factor with respect to area. Therefore, longitudinal and lateral lengths (number of dots) are to be multiplied by a square root of the size varying multiplying factor. Moreover, while operation S701 may be arranged so that an updated image size is obtained by multiplying the image size with the size varying multiplying factor, a plurality of sizes such as 800×600 and 1024×768 may be set in advance as options, whereby an image size nearest to a value obtained by multiplying by the size varying multiplying factor or the greatest value among values smaller than the value obtained by multiplying by the size varying multiplying factor may be set as the updated image size.

Subsequently, the information processing apparatus 1 executes processing of operation S204 and thereafter of the image transmission processing according to the first embodiment described earlier with reference to FIG. 6. As illustrated, the image transmission processing according to an embodiment is executed. While an embodiment has been described for an embodiment in which CPU utilization indicating the status of the terminal 2 and a packet loss rate indicating the communication status are used as feedback information, the present invention is not limited thereto. Alternatively, status information indicating a variety of statuses can be used as feedback information including the CPU type of the terminal 2, a status of the terminal 2 such as memory capacity, and a communication status such as average delay time. Subsequently, by varying the image size while taking statuses such as the communication status and the status of the terminal 2 into consideration, the processing efficiency of the entire system can be improved.

An embodiment involves transmitting an image of a segment other than a segment including a position indicated by indication information according to the first embodiment. Functions similar to those of the first embodiment shall be denoted by similar reference characters and detailed descriptions shall be omitted. Since examples of a communication system as well as hardware and software of the respective devices according to an embodiment are similar to those of the first embodiment, descriptions thereof shall be omitted.

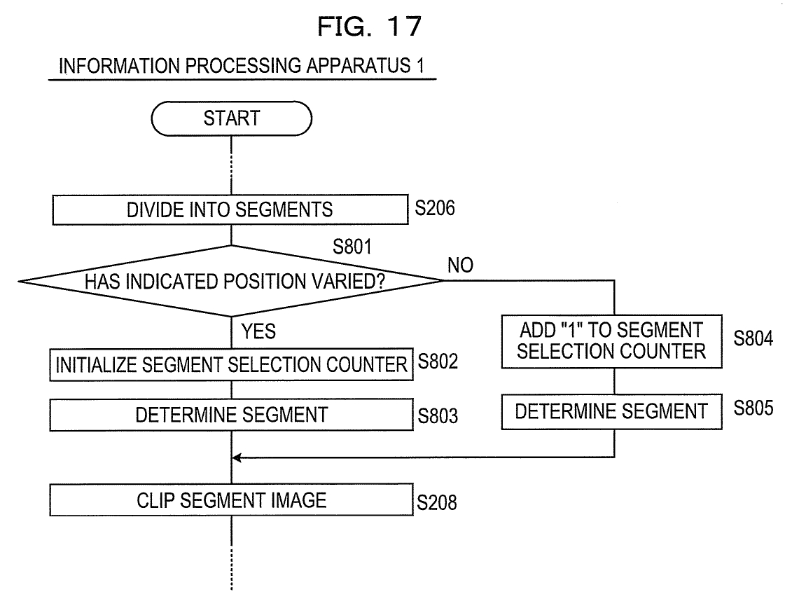

Next, processing performed by the respective devices according to an embodiment is described. An embodiment differs from the first embodiment with respect to image transmission processing. FIG. 17 is a flowchart illustrating an example of image transmission processing executed in a communication system according to an embodiment. The image transmission processing according to an embodiment differs from that of the first embodiment in the processing of operation S207 described earlier with reference to FIG. 6. An information processing apparatus 1 executes processing of operations S201 to S206 of the image transmission processing according to the first embodiment described earlier with reference to FIG. 6.

Through processing performed by a detecting section 104 under the control of a control mechanism 10 executing a computer program PRG, the information processing apparatus 1 judges whether or not the position indicated by indication information has varied (S801). A position indicated by indication information is a position on an image displayed on a screen of a display mechanism 23 of a terminal 2. Depending on the remote assistance mode, a position indicated by indication information matches a position on an image displayed on a screen of a display mechanism 14 of the information processing apparatus 1. In operation S801, whether the position has varied or not is judged based on whether the position matches a position indicated by indication information detected through previous processing. The position is judged to be unvaried when the position indicated by the previous indication information matches the position indicated by the current indication information. However, the position may also be judged to be unvaried when the difference in positions indicated by the respective pieces of indication information is equal to or smaller than a threshold or when the position indicated by the current indication information falls inside a segment including the position indicated by the previous indication information.

In operation S801, when the position is judged to be varied (S801: YES), the information processing apparatus 1 initializes a preset segment selection counter to 0 through processing performed by a segment determining section 106 under the control of the control mechanism 10 (S802), and determines a segment including the position indicated by the current, i.e., the most recently received indication information as the segment to be transmitted to the terminal 2 (S803). Subsequently, the information processing apparatus 1 executes processing of operation S208 and thereafter of the image transmission processing according to the first embodiment described earlier with reference to FIG. 6. The segment selection counter in operation S802 is, for example, a register provided at the control mechanism 10 or a counter set using a storage segment provided at the storage mechanism 13.

In operation S801, when the position is judged to be unvaried (S801: NO), the information processing apparatus 1 adds 1 to the value of the segment selection counter through processing performed by the segment determining section 106 under the control of the control mechanism 10 (S804), and determines a segment that differs from the segment including the position indicated by the current, i.e., the most recently received indication information as the segment to be transmitted to the terminal 2 (S805). In operation S805, a segment that differs from the segment including the position indicated by position indicated by the indication information is determined based on the value indicated by the segment selection counter. Subsequently, the information processing apparatus 1 executes processing of operation S208 and thereafter of the image transmission processing according to the first embodiment described earlier with reference to FIG. 6.

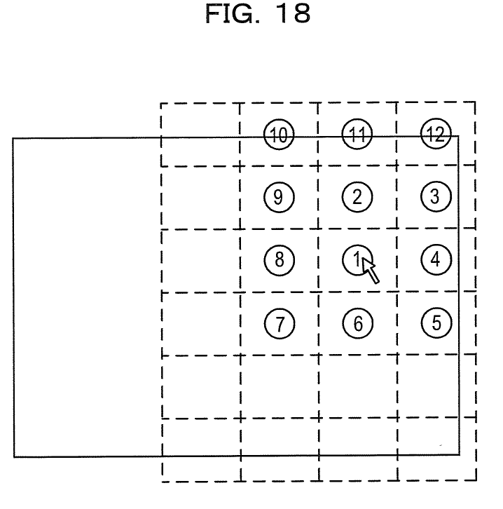

FIG. 18 is an explanatory diagram schematically illustrating an example of a segment transmitted during image transmission processing executed in the communication system according to an embodiment. In FIG. 18, the solid line represents an entire image displayed on a display mechanism 14 of the information processing apparatus 1 while the dashed line represents a segment divided based on a position indicated by indication information. The numerals illustrated in the respective segments correspond to values of the segment selection counter. The segment represented by the numeral “0” is the segment including the position indicated by the indication information. In operation S803 described earlier, a segment including the position indicated by the indication information and whose numeral is “0” is determined as the segment to be transmitted. Then, at the stage where the next image is to be transmitted, when the position indicated by the indication information has not varied, the segment whose numeral is “1” is selected as the segment to be transmitted, and when the position indicated by the indication information has not further varied, the segment whose numeral is “2” is selected as the segment to be transmitted. In other words, when the position indicated by the indication information has not moved, from the segment including the position indicated by indication information as a starting point and in a clockwise spiral, a segment bordering the segment related to the previous transmission is determined as the segment to be transmitted. Alternatively, an upper limit such as “15” may be set to the segment selection counter, whereby the segment selection counter is initialized to “0” when the upper limit is exceeded. In addition, the relationship between segments and values indicated by the segment selection counter or, in other words, a transmission sequence can be appropriately set. As illustrated, the image transmission processing according to an embodiment is executed. As illustrated, when indication information has not varied, by transmitting images of different segments in a given sequence, a skilled person operating the terminal 2 can automatically acquire images surrounding an indicator. As a result, the level of convenience of remote control can be increased.

An embodiment involves transmitting an image of a segment other than a segment including a position indicated by indication information according to the first embodiment, and differs from an embodiment in the method of determining a segment to be transmitted. Functions similar to those of the first embodiment shall be denoted by similar reference characters and detailed descriptions shall be omitted. Since examples of a communication system as well as hardware of the respective devices according to an embodiment are similar to those of the first embodiment, descriptions thereof shall be omitted.

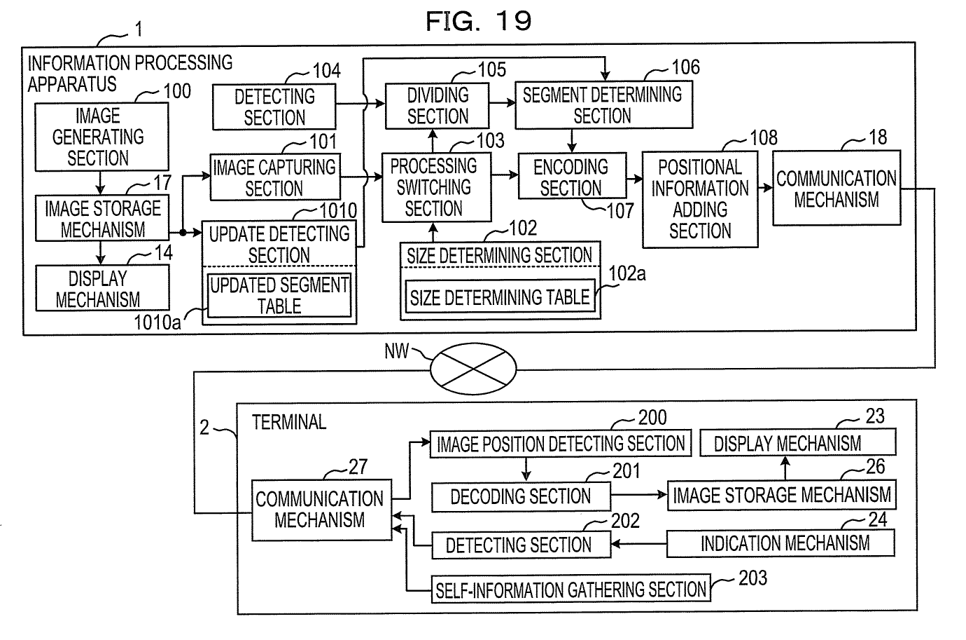

FIG. 19 is a functional block diagram illustrating an example of software of respective devices constituting the communication system according to an embodiment. An information processing apparatus 1 realizes a variety of functions as various program modules including an image generating section 100, an image capturing section 101, a size determining section 102 having a size determining table 102a, a processing switching section 103, a detecting section 104, a dividing section 105, a segment determining section 106, an encoding section 107, a positional information adding section 108, and an update detecting section 1010 having an updated segment table 1010a.

The updated segment table 1010a is a table that records information regarding updated windows displayed on a screen of a display mechanism 14 of the information processing apparatus 1. The update detecting section 1010 functions to detect an update status of an image displayed on the display mechanism 14.

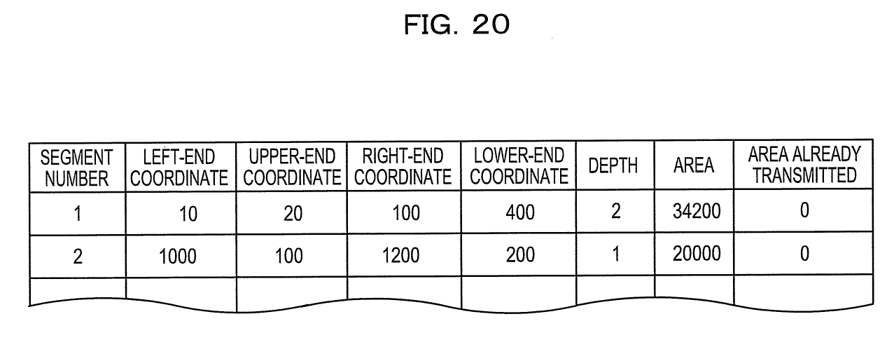

FIG. 20 is an explanatory diagram schematically illustrating an example of recorded contents of the updated segment table 1010a provided in the information processing apparatus 1 according to an embodiment. The updated segment table 1010a records, on a per-record basis, information regarding updated windows among windows displayed on the screen of the display mechanism 14. Recorded for each table is information regarding an updated window including a segment number, a left-end coordinate, an upper-end coordinate, a right-end coordinate, a lower-end coordinate, depth (Z order), area, and area already transmitted. A segment number refers to a number attached to an updated segment. The left-end coordinate, the upper-end coordinate, the right-end coordinate, and the lower-end coordinate are coordinates indicating the position of an updated segment. An updated segment recorded in the updated segment table 1010a refers to a four-sided rectangular updated segment those respective sides are parallel or vertical with respect to a lower side of a rectangular screen on the display mechanism 14. Therefore, the updated segment table 1010a indicates a position, shape, and area of an updated segment based on the left-end coordinate, the upper-end coordinate, the right-end coordinate, and the lower-end coordinate. The depth refers to a depth of window layers where a window in the forefront of the display screen is 1 and the deeper the window, the bigger the number. When a window does not exist in an updated segment, the deepest (the largest number) is used. The area refers to an area of an updated segment. The area already transmitted refers to a total area already transmitted to a terminal 2 among an updated segment. The example illustrated in FIG. 20 represents a status prior to transmission and, accordingly, the area already transmitted is “0”.

As for records in the updated segment table 1010a illustrated in FIG. 20, when a new window is opened or a window is closed, a corresponding record is recorded. In addition, due to image transmission processing to be described later, a record is deleted as required. Moreover, when there is a variation in the position, shape or size of an image displayed in a window already displayed or in the position, shape or size of the window, i.e., when the contents of a window is updated, the recorded contents of a record corresponding to the updated window is also updated.

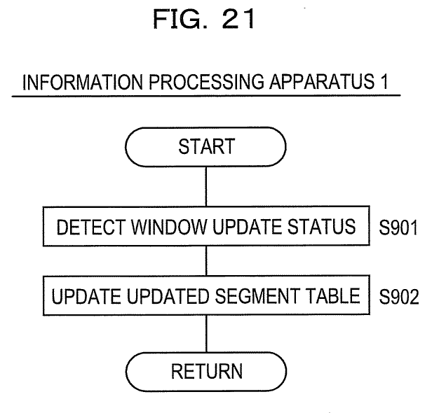

Next, processing performed by the respective devices according to an embodiment is described. In an embodiment, update detection processing is executed concurrently with the processing performed in the first embodiment. FIG. 21 is a flowchart illustrating an example of update detection processing executed in the communication system according to an embodiment. Through processing of the update detecting section 1010 under the control of a control mechanism 10 that executes a computer program PRG, the information processing apparatus 1 detects a status regarding update of a window within an image to be displayed on the display mechanism 14 (S901), and updates the updated segment table 1010a based on the detected update status (S902). In operation S901, the information processing apparatus 1 detects a status regarding an update of a window based on information such as an instruction causing the image generating section 100 to render an image, the image generated by the image generating section 100, and an image stored by the image storage mechanism 17. A status regarding update of a window refers to, for example, a status at which a new window is opened, a status at which a window is closed, or a status at which a variation has occurred in an image displayed in a window or in the position, the shape, or the size of a window. As illustrated, the update detection processing according to an embodiment is executed.

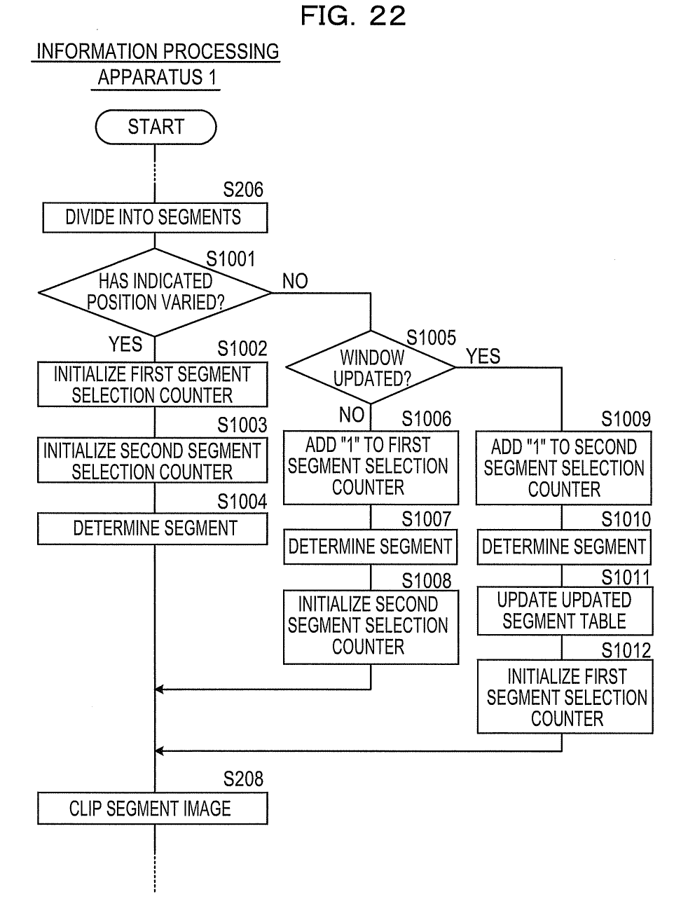

With the image transmission processing according to an embodiment, a segment to be transmitted is determined based on the updated segment table 1010a whose recorded contents are updated by the update detection processing. FIG. 22 is a flowchart illustrating an example of image transmission processing executed in the communication system according to an embodiment. The image transmission processing according to an embodiment differs from that of the first embodiment in the processing of operation S207 of the image transmission processing according to the first embodiment described earlier with reference to FIG. 6. The information processing apparatus 1 executes processing of operations S201 to S206 of the image transmission processing according to the first embodiment described earlier with reference to FIG. 6. In the image transmission processing according to an embodiment, two segment selection counters are used.

Through processing performed by the detecting section 104 under the control of the control mechanism 10 executing a computer program PRG, the information processing apparatus 1 judges whether a position indicated by indication information has varied or not (S1001).

In operation S1001, when the position is judged to be varied (S1001: YES), through processing performed by the segment determining section 106 under the control of the control mechanism 10, the information processing apparatus 1 initializes a first segment selection counter to 0 (S1002) and a second segment selection counter to 0 (S1003). Subsequently, through processing of the segment determining section 106 under the control of the control mechanism 10, the information processing apparatus 1 determines the segment including the position indicated by the current, i.e., the most recently received indication information as the segment to be transmitted to the terminal 2 (S1004). The information processing apparatus 1 then executes processing of operation S208 and thereafter of the image transmission processing according to the first embodiment described earlier with reference to FIG. 6.

In operation S1001, when the position is judged to be unvaried (S1001: NO), through processing performed by the update detecting section 1010 under the control of the control mechanism 10, the information processing apparatus 1 judges whether a window has been updated or not (S1005). In operation S1005, the window is judged to have been updated when a record has been recorded in the updated segment table 1010a.

In operation S1005, when it is judged that an update has not been performed (S1005: NO), the information processing apparatus 1 adds 1 to the value of the first segment selection counter through processing performed by the segment determining section 106 under the control of the control mechanism 10 (S1006), and determines a segment that differs from the segment including the position indicated by the current, i.e., the most recently received indication information as the segment to be transmitted to the terminal 2 (S1007). In operation S1007, a segment that differs from the segment including the position indicated by position indicated by the indication information is determined based on the value indicated by the first segment selection counter. Through processing of the segment determining section 106 under the control of the control mechanism 10, the information processing apparatus 1 initializes the second segment selection counter to 0 (S1 008), and then executes processing of operation S208 and thereafter of the image transmission processing according to the first embodiment described earlier with reference to FIG. 6.

In operation S1005, when it is judged that an update has been performed (S1005: YES), through processing performed by the segment determining section 106 under the control of the control mechanism 10, the information processing apparatus 1 adds 1 to the second segment selection counter (S1009). Subsequently, through processing of the segment determining section 106 under the control of the control mechanism 10, the information processing apparatus 1 references a record recorded in the updated segment table 1010a and determines a segment whose image is partially or entirely updated as the segment to be transmitted to the terminal 2 (S1010). In operation S1010, a segment to be transmitted is determined based on the value indicated by the second segment selection counter. In this case, the information processing apparatus 1 judges whether a segment has been updated or not in a clockwise spiral from a segment including the position indicated by indication information as a starting point, and determines the segment judged as being updated as a segment to be transmitted in the order in which the segments are judged.

Due to processing performed by the update detecting section 1010 under the control of the control mechanism 10, the information processing apparatus 1 updates the recorded contents of the updated segment table 1010a (S1011). In operation S1011, update is performed so as to increase the “area already transmitted” of a record related to the segment whose image has been transmitted. Furthermore, when the area already transmitted and the area of the segment become equal or, in other words, when the transmission of all updated segments of the record has been completed, update is performed in order to delete the record. Subsequently, through processing of the segment determining section 106 under the control of the control mechanism 10, the information processing apparatus 1 initializes the first segment selection counter to 0 (S1012), and then executes processing of operation S208 and thereafter of the image transmission processing according to the first embodiment described earlier with reference to FIG. 6.

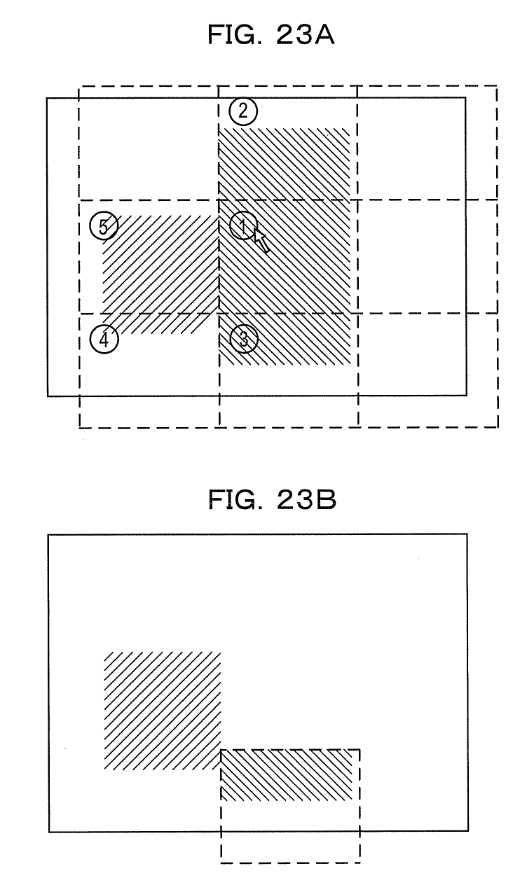

FIG. 23 is an explanatory diagram schematically illustrating an example of segments transmitted during image transmission processing executed in the communication system according to an embodiment. In FIG. 23A, the solid line represents an entire image displayed on the screen, the dashed line segments, and the diagonal lines a range of an updated window. The information processing apparatus 1 judges whether a segment has been updated or not in a clockwise spiral from a segment including the position indicated by indication information as a starting point, and transmits images of segments in the order in which the segments had been judged to be updated. In the example illustrated in FIG. 23A, images of segments are transmitted in a sequence of the numbers illustrated in the segments. Moreover, FIG. 23B illustrates a status in which after images of the segment denoted by “1” and the segment denoted by “2” are transmitted, the image denoted by “3” is selected as the segment image to be transmitted.

As illustrated in FIG. 23, when there is a plurality of segments including updated images, the respective images are to be transmitted at image transmission intervals of 1/30 seconds or the like. However, there is a possibility that an image is updated before all updated segment images are transmitted. Therefore, the second segment selection counter may be arranged to be initialized every time an image is updated, whereby transmission is carried out from the beginning or, in other words, the segment nearest to the position indicated by the indication information. As illustrated, the image transmission processing according to an embodiment is executed. By preferentially transmitting a segment associated with an updated image in this manner, the level of convenience of remote control can be increased.

An embodiment involves determining a sequence of segments with respect to images to be transmitted using a method different from that used in an embodiment. Functions similar to those of the first or sixth embodiment shall be denoted by similar reference characters and detailed descriptions shall be omitted. Since examples of a communication system as well as hardware and software of the respective devices according to an embodiment are similar to those of an embodiment, descriptions thereof shall be omitted.

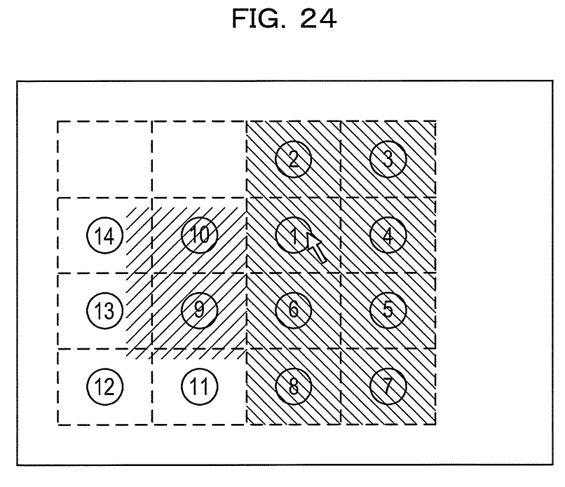

Respective processing performed in an embodiment is similar to that of an embodiment. However, an embodiment differs in the determination method of operation S1010 of the image transmission processing according to an embodiment described earlier with reference to FIG. 22. FIG. 24 is an explanatory diagram illustrating an example of segments transmitted during image transmission processing executed in a communication system according to an embodiment. In FIG. 24, the solid line represents an entire image displayed on the screen, the dashed line segments, and the diagonal lines a range of an updated window. Moreover, it is illustrated that the range represented by the diagonal lines oriented from top left to bottom right is anterior to the range represented by the diagonal lines oriented from top right to bottom left. In an embodiment, a transmission sequence is determined using data related to depth recorded in an updated segment table 1010a.

When determining a transmission sequence, a segment related to a window in an anterior layer is given priority. With segments associated to the same window, a judgment is made on whether a segment has been updated or not in a clockwise spiral sequence from a segment including a position indicated by indication information or a segment nearest to the position indicated by the indication information as a starting point. When a segment is judged to be updated, priority is then assigned according to depth. For example, in the example illustrated in FIG. 24, images of segments are transmitted in a sequence of numbers illustrated in the segments. By preferentially transmitting an image of a segment associated with a window of an anterior layer in this manner, an image associated with a used window is to be preferentially transmitted, thereby increasing the level of convenience of remote control.

An embodiment involves transmitting an image of a same segment for a given number of times (a given period of time) according to the first embodiment. Functions similar to those of the first embodiment shall be denoted by similar reference characters and detailed descriptions shall be omitted. Since examples of a communication system as well as hardware and software of the respective devices according to an embodiment are similar to those of the first embodiment, descriptions thereof shall be omitted.

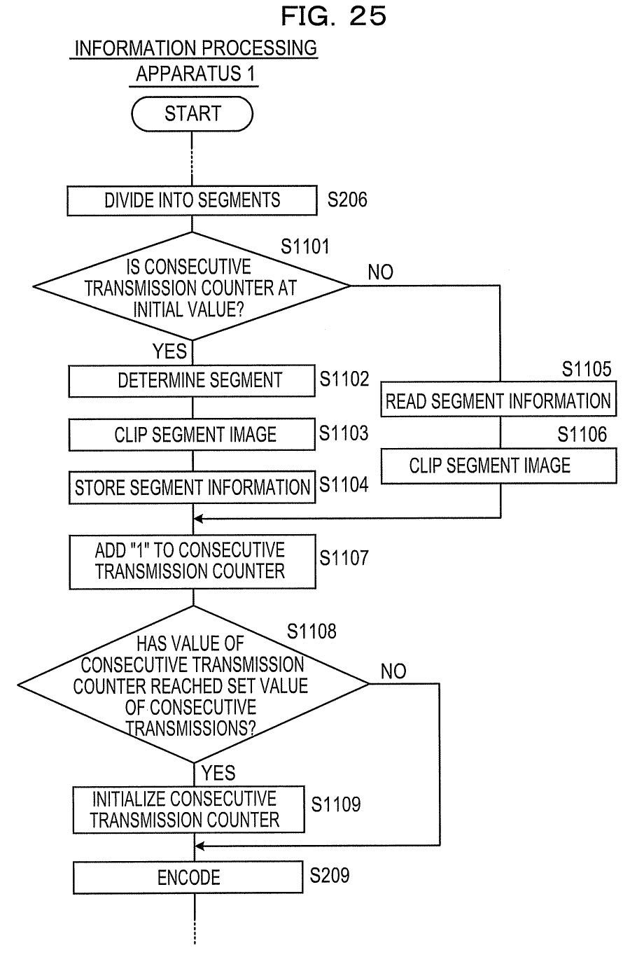

Next, processing performed by the respective devices according to an embodiment is described. An embodiment differs from the first embodiment with respect to image transmission processing. FIG. 25 is a flowchart illustrating an example of image transmission processing executed in the communication system according to an embodiment. The image transmission processing according to an embodiment differs from that of the first embodiment in the processing of operation S207 in the image transmission processing according to the first embodiment described earlier with reference to FIG. 6. An information processing apparatus 1 executes processing of operations S201 to S206 of the image transmission processing according to the first embodiment described earlier with reference to FIG. 6.

Through processing performed by a segment determining section 106 under the control of a control mechanism 10 executing a computer program PRG, the information processing apparatus 1 judges whether or not a consecutive transmission counter is at an initial value of 0 (S1101). The consecutive transmission counter in operation S1101 is, for example, a register provided at the control mechanism 10 or a counter set using a storage segment provided at the storage mechanism 13.

in operation S1101, when it is judged that the consecutive transmission counter is at an initial value of 0 (S1101: YES), through processing performed by the segment determining section 106 under the control of the control mechanism 10, the information processing apparatus 1 determines an image of a segment including a position indicated by indication information as the segment image to be transmitted to the terminal 2 (S1102).

Due to processing performed by an image capturing section 101 under the control of the control mechanism 10, the information processing apparatus 1 clips a segment image that is an image of the determined segment from the full-screen image acquired through processing of operation S202 described earlier with reference to FIG. 6 (S1103), and stores segment information indicating the position and size of the clipped segment through processing performed by the segment determining section 106 (S1104).

In operation S1101, when it is judged that the consecutive transmission counter is not at an initial value of 0 (S1101: NO), through processing performed by the segment determining section 106 under the control of the control mechanism 10, the information processing apparatus 1 reads the segment information indicating the position and size of the segment previously stored from the storage mechanism 13 (S1105), and through processing performed by the image capturing section 101, clips a segment image of the segment indicated by the segment information from the full-screen image (S1106). The segment image information read in operation S1105 is the segment image information stored through processing of the previous operation S1104. Therefore, the segment image clipped in operation S1106 is the same as the segment image clipped in operation S1103. Moreover, design can be performed appropriately such as fixing a position based on the segment information but varying size.

After operation S1104 or operation S1106, through processing performed by the segment determining section 106 under the control of the control mechanism 10, the information processing apparatus 1 adds 1 to the value of the consecutive transmission counter (S1107) and compares the value with a set value of consecutive transmissions (S1108). The set value of consecutive transmissions is an upper limit of consecutive transmissions set using, for example, a register provided at the control mechanism 10 or a storage segment provided at a storage mechanism 13.

In operation S1108, when it is judged that the value of the consecutive transmission counter has reached the set value of consecutive transmissions (S1108: YES), through processing performed by the segment determining section 106 under the control of the control mechanism 10, the information processing apparatus 1 performs initialization processing in which the segment image stored by the storage mechanism 13 is deleted and the value of the consecutive transmission counter is reset to 0 (S1109), and executes operation S209 and thereafter of the image transmission processing according to the first embodiment described earlier with reference to FIG. 6.

In operation S1108, when it is judged that the value of the consecutive transmission counter has not reached the set value of consecutive transmissions (S1108: NO), the information processing apparatus 1 executes operation S209 and thereafter of the image transmission processing according to the first embodiment described earlier with reference to FIG. 6. As illustrated, the image transmission processing according to an embodiment is executed. By transmitting the same segment image a given number of times or, in other words, for a given period of time in this manner, variations in the transmitted image can be suppressed and the compression efficiency during encoding can be improved.

An embodiment involves transmitting an updated segment image in the manner described for an embodiment and repetitively transmitting a same segment image in the manner described for an embodiment. However, instead of simply repetitively transmitting an updated segment image, in an embodiment, the number of repetitions is dynamically varied depending on the area of a segment to be transmitted and the size of a transmitted image. Functions similar to those of the first, sixth or eighth embodiment shall be denoted by similar reference characters and detailed descriptions shall be omitted.

In image transmission processing performed in an embodiment, a set value of consecutive transmissions is calculated according to the following Formula (3) using an image size determined by a size determining section 102 and an area of an updated image detected by an update detecting section 1010.

Set value of consecutive transmissions=Constant/(Area of updated image/image size) Formula (3)

In Formula (3), the constant is a value such as 12 which can be appropriately set. Alternatively, approximation may be performed so that the set value of consecutive transmissions calculated using Formula (3) becomes a natural number. With the set value of consecutive transmissions calculated using Formula (3), the greater the area of the updated image, the smaller the set value of consecutive transmissions. As a result, since the number of times the same segment image is transmitted becomes smaller, an image with a large area can now be transmitted in a short period of time. In addition, the smaller the area of the updated image, the larger the set value of consecutive transmissions. As a result, the compression efficiency during encoding can be improved. In addition, with the set value of consecutive transmissions calculated by Formula (3), the greater the size of the image in one transmission, the greater the set value of consecutive transmissions. As a result, the compression efficiency during encoding can be improved. Furthermore, the smaller the size of the image in one transmission, the smaller the set value of consecutive transmissions. As a result, when there is a large number of updated segments, images of all segments can be transmitted within a short period of time. As illustrated, an embodiment ensures that the compression efficiency during encoding is appropriate and is capable of transmitting all updated images within a short period of time.

An embodiment involves transmitting an updated image in the same manner as described for an embodiment and, in addition, dynamically setting an image transmission time interval that is set as a frame rate depending on the size of an image to be transmitted. Functions similar to those of the first or sixth embodiment shall be denoted by similar reference characters and detailed descriptions shall be omitted. Since examples of a communication system as well as hardware and software of the respective devices according to an embodiment are similar to those of an embodiment, descriptions thereof shall be omitted.

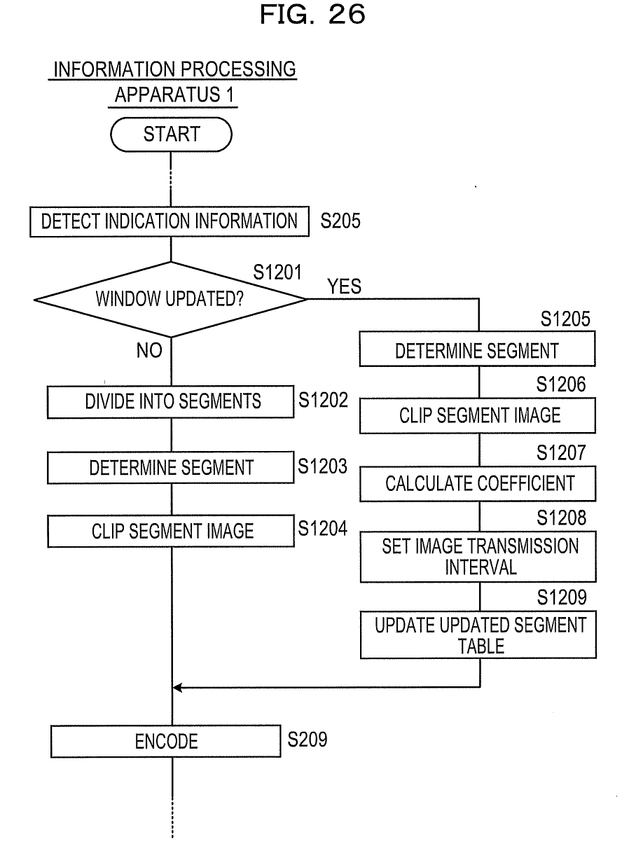

Next, processing performed by the respective devices according to an embodiment is described. In an embodiment, the same update detection processing as an embodiment is performed. Furthermore, an embodiment differs from the above-identified embodiments with respect to image transmission processing. FIG. 26 is a flowchart illustrating an example of image transmission processing executed in the communication system according to an embodiment. The image transmission processing according to an embodiment differs from that of the first embodiment in the processing of operation S206 and thereafter in the image transmission processing according to an embodiment described earlier with reference to FIG. 6. An information processing apparatus 1 executes processing of operations S201 to S205 of the image transmission processing according to an embodiment described earlier with reference to FIG. 6.

Through processing performed by an update detecting section 1010 under the control of a control mechanism 10 executing a computer program PRG, the information processing apparatus 1 judges whether or not a window has been updated (S1201).

In operation S1201, when it is judged that an update has not been performed (S1201: NO), through processing performed by a dividing section 105 under the control of the control mechanism 10, the information processing apparatus 1 divides a full-screen image displayed on a display mechanism 14 into a plurality of segments based on an image size determined by a size determining section 102 (S1202), and through processing performed by a segment determining section 106, determines an image of a segment including a position indicated by indication information as the segment image to be transmitted to the terminal 2 (S1203).

Through processing performed by an image capturing section 101 under the control of the control mechanism 10, the information processing apparatus 1 clips a segment image that is an image of the determined segment from the full-screen image acquired through processing of operation S202 described earlier with reference to FIG. 6 (S1204). The information processing apparatus 1 then executes processing of operation S209 and thereafter of the image transmission processing according to an embodiment described earlier with reference to FIG. 6.

In operation S1201, when it is judged that an update has been performed (S1201: YES), through processing performed by the segment determining section 106 and the update detecting section 1010 under the control of the control mechanism 10, the information processing apparatus 1 determines a segment including a range of an image associated with a window whose image has been updated as the segment image to be transmitted to the terminal 2 (S1205). The segment determined in operation S1205 does not result from dividing a full-screen image into a plurality of segments based on image size as is the case of operation S1202. Therefore, the size and shape of the image do not necessarily match.

Through processing performed by the image capturing section 101 under the control of the control mechanism 10, the information processing apparatus 1 clips a segment image that is an image of the determined segment (S1206).

Under the control of the control mechanism 10, the information processing apparatus 1 calculates a coefficient set with respect to an image transmission interval according to Formula (4) below using an image size determined by the size determining section 102 and an area of the segment determined in operation S1205 (S1207).

Coefficient=Area of segment/Image size Formula (4)

Under the control of the control mechanism 10, the information processing apparatus 1 sets a numerical value obtained by multiplying the image transmission interval by the calculated coefficient as the new image transmission interval (S1208). The image transmission interval set in operation S1208 is to be used as a time interval only until the next image transmission.

Subsequently, through processing performed by the update detecting section 1010 under the control of the control mechanism 10, the information processing apparatus 1 updates an updated segment table 1010a in order to delete a record associated with the updated window and which is recorded in the updated segment table 1010a (S1209). The information processing apparatus 1 then executes processing of operation S209 and thereafter of the image transmission processing according to an embodiment described earlier with reference to FIG. 6.

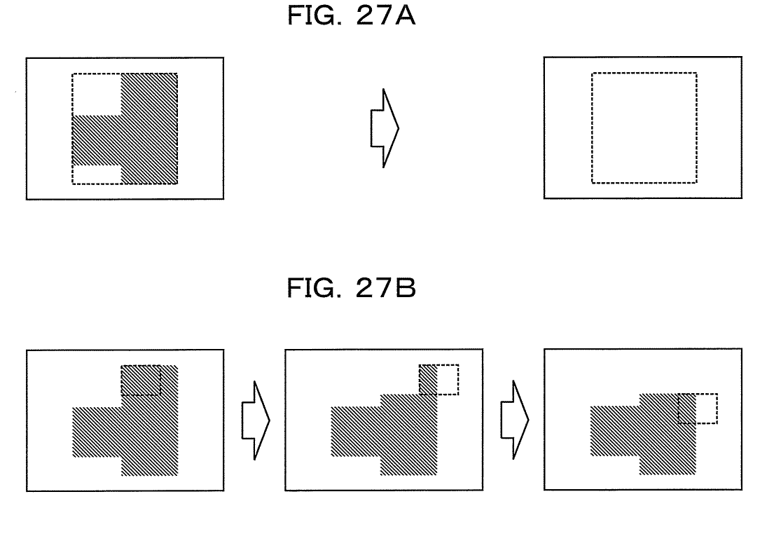

FIG. 27 is an explanatory diagram illustrating an example of segments transmitted during image transmission processing executed in the communication system according to an embodiment. In FIG. 27, the solid line represents an entire image displayed on the screen, the dashed line segments to be transmitted, and the diagonal lines a range of an updated window. FIG. 27A illustrates a time series variation of a segment due to image transmission processing according to an embodiment, while FIG. 27B illustrates, for comparison, a time series variation of a segment due to image transmission processing according to an embodiment. A comparison between FIG. 27A and FIG. 27B reveals that when a wide range is set as a segment, the image transmission interval lengthens. In other words, even when the area of the segment to be transmitted increases by a factor of N, processing load can now be kept constant by lowering the frame date by a factor of 1/N. As illustrated, the image transmission processing according to an embodiment is executed.

An embodiment involves determining a segment to be transmitted regardless of the position of an indicator and an updated image according to an embodiment. Functions similar to those of the above-identified embodiment shall be denoted by similar reference characters and detailed descriptions shall be omitted. Since examples of a communication system as well as hardware and software of the respective devices according to an embodiment are similar to those of an embodiment described above, descriptions thereof shall be omitted.

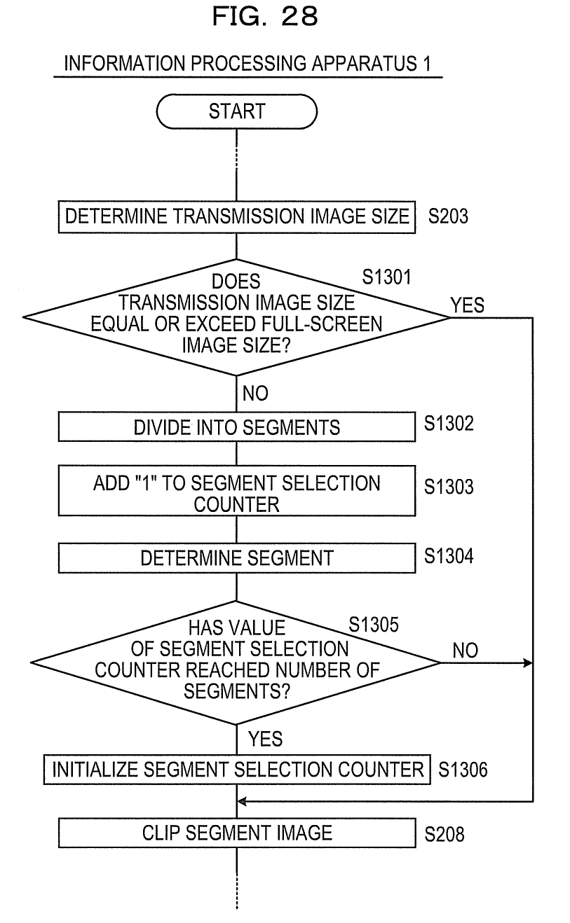

Next, processing performed by the respective devices according to an embodiment is described. An embodiment differs from the first embodiment with respect to image transmission processing. FIG. 28 is a flowchart illustrating an example of image transmission processing executed in the communication system according to an embodiment. The image transmission processing according to an embodiment differs from that of an embodiment described above in the processing of operation S204 and thereafter in the image transmission processing according to the embodiment described earlier with reference to FIG. 6. An information processing apparatus 1 executes processing of operations S201 to S203 of the image transmission processing according to the embodiment described earlier with reference to FIG. 6.

Through processing performed by a processing switching section 103 under the control of a control mechanism 10 executing a computer program PRG, the information processing apparatus 1 judges whether or not the size of the image to be transmitted is equal to or greater than the size of a full-screen image displayed by a display mechanism 14 or, in other words, the size of a so-called desktop screen (S1301).

In operation S1301, when it is judged that the size of the transmission image is smaller than the desktop screen size (S1301: NO), through processing performed by a dividing section 105 under the control of the control mechanism 10, the information processing apparatus 1 divides a full-screen image displayed by a display mechanism 14 based on the image size determined by a size determining section 102 into a plurality of segments (S1302).

Through processing of an segment determining section 106 under the control of the control mechanism 10, the information processing apparatus 1 adds 1 to the value of a segment selection counter (S1303), and determines an image of a segment to be transmitted to the terminal 2 among the plurality of segments based on the value of the segment selection counter (S1304). The segment selection counter in operation S1303 is, for example, a register provided at the control mechanism 10 or a counter set using a storage segment provided at the storage mechanism 13.

Through processing performed by the segment determining section 106 under the control of the control mechanism 10, the information processing apparatus 1 judges whether or not the value of the segment selection counter has reached the number of segments (S1305). The number of segments in operation S1305 refers to the number of segments divided in operation S1302. In other words, in operation S1305, a judgment is made on whether or not images of all segments have been transmitted.

In operation S1305, when it is judged that the number of segments has been reached (S1305: YES), through processing performed by the segment determining section 106 under the control of the control mechanism 10, the information processing apparatus 1 initializes the segment selection counter to a value of 0 (S1306). The information processing apparatus 1 then executes processing of operation S208 and thereafter of the image transmission processing according to the embodiment described earlier with reference to FIG. 6.

When it is judged in operation S1305 that the number of segments has not been reached (S1305: NO) or when it is judged in operation S1301 that the size of the transmission image is equal to or greater than the size of the desktop screen (S1301: YES), the information processing apparatus 1 executes operation S208 and thereafter of the image transmission processing according to the embodiment described earlier with reference to FIG. 6.

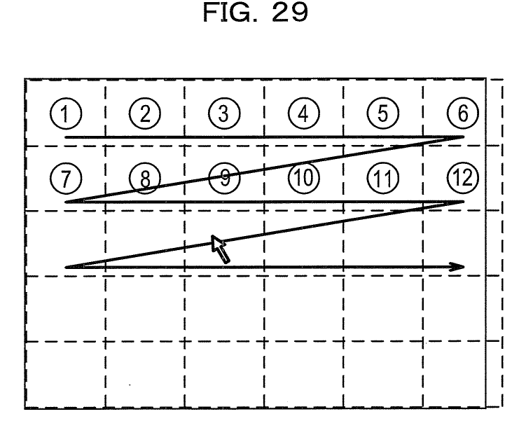

FIG. 29 is an explanatory diagram illustrating an example of segments transmitted during image transmission processing executed in the communication system according to an embodiment. In FIG. 29, the solid line represents an entire image displayed on the screen while the dashed line represents segments. The numerals illustrated in the respective segments correspond to values of the segment selection counter. In the example illustrated in FIG. 29, as indicated by the arrow, transmission proceeds in a sequence starting from the segment on the top left of the screen to the segments to the right thereof, and then to the segments in the level immediately underneath. As illustrated, the image transmission processing according to an embodiment is executed. The communication system according to an embodiment realizes suppression of processing load through processing simplification.

An embodiment involves determining a segment to be transmitted regardless of the position of an indicator according to an above-described embodiment. However, unlike an embodiment, an embodiment involves preferentially transmitting an image of an updated segment in the same manner as illustrated for an embodiment. Functions similar to those of the embodiments described above shall be denoted by similar reference characters and detailed descriptions shall be omitted. Since examples of a communication system as well as hardware and software of the respective devices according to an embodiment are similar to those of an embodiment, descriptions thereof shall be omitted.

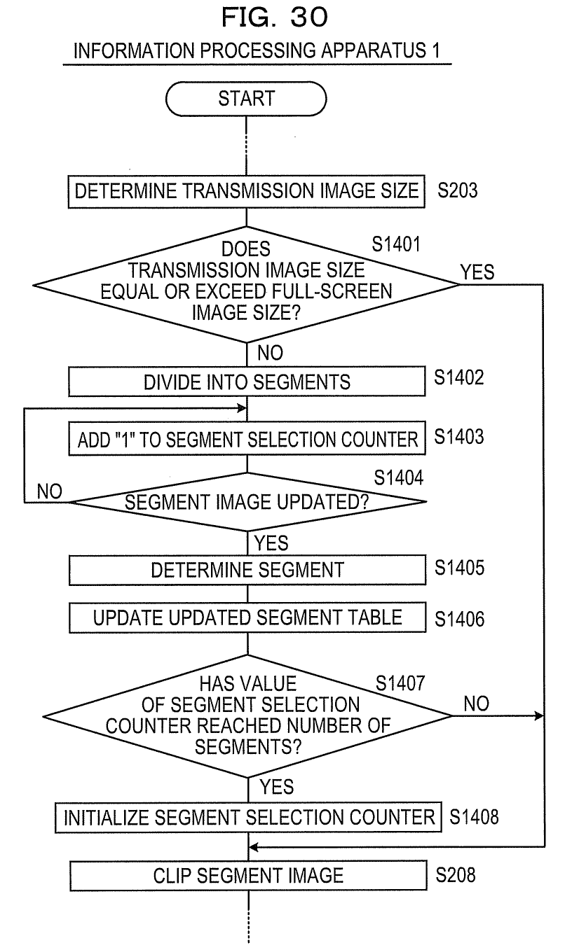

Next, processing performed by the respective devices according to an embodiment is described. In an embodiment, the same update detection processing as an embodiment is performed. Furthermore, an embodiment differs from the above-described embodiments with respect to image transmission processing. FIG. 30 is a flowchart illustrating an example of image transmission processing executed in the communication system according to an embodiment. The image transmission processing according to an embodiment differs from that of the embodiment described above in the processing of operation S204 and thereafter in the image transmission processing according to the embodiment described earlier with reference to FIG. 6. An information processing apparatus 1 executes processing of operations S201 to S203 of the image transmission processing according to the embodiment described earlier with reference to FIG. 6.

Through processing performed by a processing switching section 103 under the control of a control mechanism 10 executing a computer program PRG, the information processing apparatus 1 judges whether or not the size of the image to be transmitted is equal to or greater than the size of a full-screen image displayed by a display mechanism 14 or, in other words, the size of a so-called desktop screen (S1401).

In operation S1401, when it is judged that the size of the transmission image is smaller than the desktop screen size (S1401: NO), through processing performed by a dividing section 105 under the control of the control mechanism 10, the information processing apparatus 1 divides a full-screen image displayed by a display mechanism 14 based on the image size determined by a size determining section 102 into a plurality of segments (S1402).

Due to processing performed by a segment determining section 106 under the control of the control mechanism 10, the information processing apparatus 1 adds 1 to the value of a segment selection counter (S1403). The segment selection counter in operation S1403 is, for example, a register provided at the control mechanism 10 or a counter set using a storage segment provided at the storage mechanism 13.

Through processing performed by an update detecting section 1010 under the control of the control mechanism 10, the information processing apparatus 1 references an updated segment table 1010a to judge whether or not an image of a segment corresponding to the value of the updated segment table has been updated (S1404).

In operation S1404, when it is judged that the image of the segment corresponding to the value of the segment selection counter has been updated (S1404: YES), through processing performed by the segment determining section 106 under the control of the control mechanism 10, the information processing apparatus 1 determines an image of the segment corresponding to the value of the segment selection counter to be the segment image to be transmitted to the terminal 2 (S1405).

Due to processing performed by an update detecting section 1010 under the control of the control mechanism 10, the information processing apparatus 1 updates the recorded contents of an updated segment table 1010a (S1406). In operation S1406, update is performed so as to increase the “area already transmitted” of a record related to the segment whose image has been transmitted. Furthermore, when the area already transmitted and the area of the segment become equal or, in other words, when the transmission of all updated segments of the record has been completed, update is performed in order to delete the record.

Through processing performed by the segment determining section 106 under the control of the control mechanism 10, the information processing apparatus 1 judges whether or not the value of the segment selection counter has reached the number of segments (S1407).

In operation S1407, when it is judged that the number of segments has been reached (S1407: YES), through processing performed by the segment determining section 106 under the control of the control mechanism 10, the information processing apparatus 1 initializes the segment selection counter to a value of 0 (S1408). The information processing apparatus 1 then executes processing of operation S208 and thereafter of the image transmission processing according to the embodiment described earlier with reference to FIG. 6.

In operation S1407, when it is judged that the value of the segment selection counter has not reached the number of segments (S1407: NO), the information processing apparatus 1 executes operation S208 and thereafter of the image transmission processing according to the embodiment described earlier with reference to FIG. 6.

In operation S1404, when it is judged that the image of the segment corresponding to the value of the segment selection counter has not been updated (S1404: NO), the information processing apparatus 1 returns to operation S1403 to repetitively perform subsequent processing.

In operation S1401, when it is judged that the size of the transmission image is equal to or greater than the size of the desktop screen (S1401: YES), the information processing apparatus 1 executes operation S208 and thereafter of the image transmission processing according to the embodiment described earlier with reference to FIG. 6.

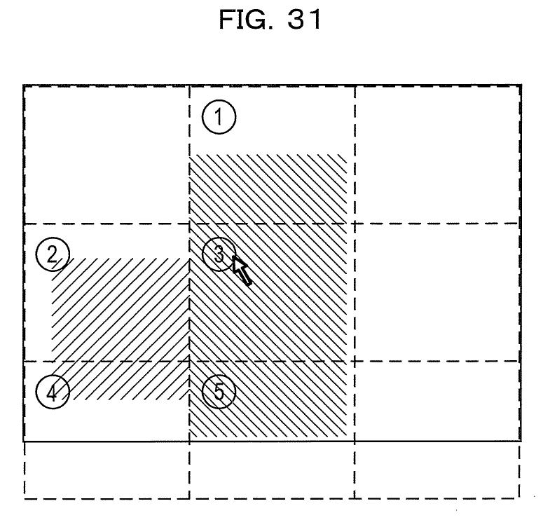

FIG. 31 is an explanatory diagram schematically illustrating an example of segments transmitted during image transmission processing executed in the communication system according to an embodiment. In FIG. 31, the solid line represents an entire image displayed on the screen, the dashed line segments, and the diagonal lines a range of an updated window. In addition, the numerals illustrated in the respective segments correspond to values of the segment selection counter. In the example illustrated in FIG. 31, transmission proceeds in a sequence starting from the segment on the top left of the screen to the segments to the right thereof, and then to the segments in the level immediately underneath. However, segments to be transmitted are limited to those updated. If there are no updated segments, the same processing as an embodiment is executed. As illustrated, the image transmission processing according to an embodiment is executed. By preferentially transmitting a segment associated with an updated image in this manner, the level of convenience of remote control can be increased.

An embodiment involves determining a transmission sequence according to an embodiment while taking updated window depth into consideration. In other words, this embodiment involves applying the processing related to determining a segment to be transmitted described for an embodiment to an embodiment. Functions similar to those of the above described embodiments shall be denoted by similar reference characters and detailed descriptions shall be omitted. Since examples of a communication system as well as hardware and software of the respective devices according to this embodiment are similar to those of an embodiment, descriptions thereof shall be omitted.

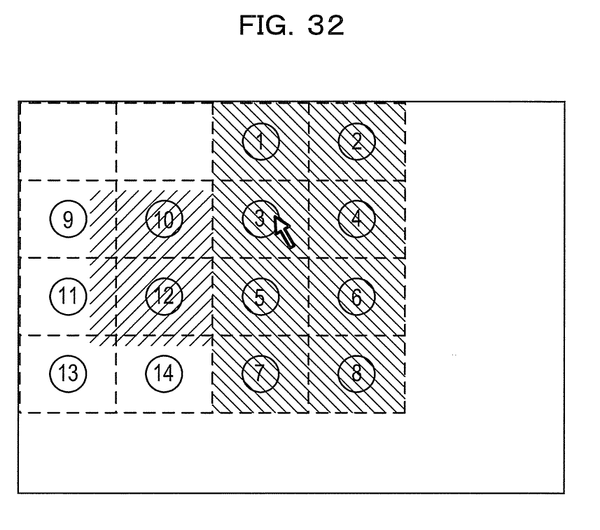

Respective processing performed in this embodiment is substantially similar to that of an embodiment. However, since a transmission sequence is to be determined while also taking window depth into consideration, a sequence in which segments are transmitted differs from an embodiment. FIG. 32 is an explanatory diagram illustrating an example of segments transmitted during image transmission processing executed in the communication system according to this embodiment. In FIG. 32, the solid line represents an entire image displayed on the screen, the dashed line segments, and the diagonal lines a range of an updated window. Moreover, it is illustrated that the range represented by the diagonal lines oriented from top left to bottom right is anterior to the range represented by the diagonal lines oriented from top right to bottom left. In an embodiment, a transmission sequence is determined using data related to depth recorded in an updated segment table 1010a.

When determining a transmission sequence, a segment related to a window in an anterior layer is given priority. With segments of the same window, as described earlier for an embodiment, an order of precedence is determined from the top left segment to the bottom right segment. The numbers illustrated in the segments in FIG. 32 indicate a sequence in which segments are to be transmitted. By preferentially transmitting an image of a segment associated with a window of an anterior layer in this manner, an image associated with a window in use is to be preferentially transmitted, thereby increasing the level of convenience of remote control.

An embodiment involves implementing, as a processing circuit such as a chipset using an integrated circuit such as a VLSI, a coprocessor, or the like, i.e., hardware, the various functions realized in the above-identified embodiment by executing a computer program that is software. Functions similar to those of the first embodiment shall be denoted by similar reference characters and detailed descriptions shall be omitted. Since examples of a communication system according to an embodiment are similar to those of the embodiment described above, descriptions thereof shall be omitted.

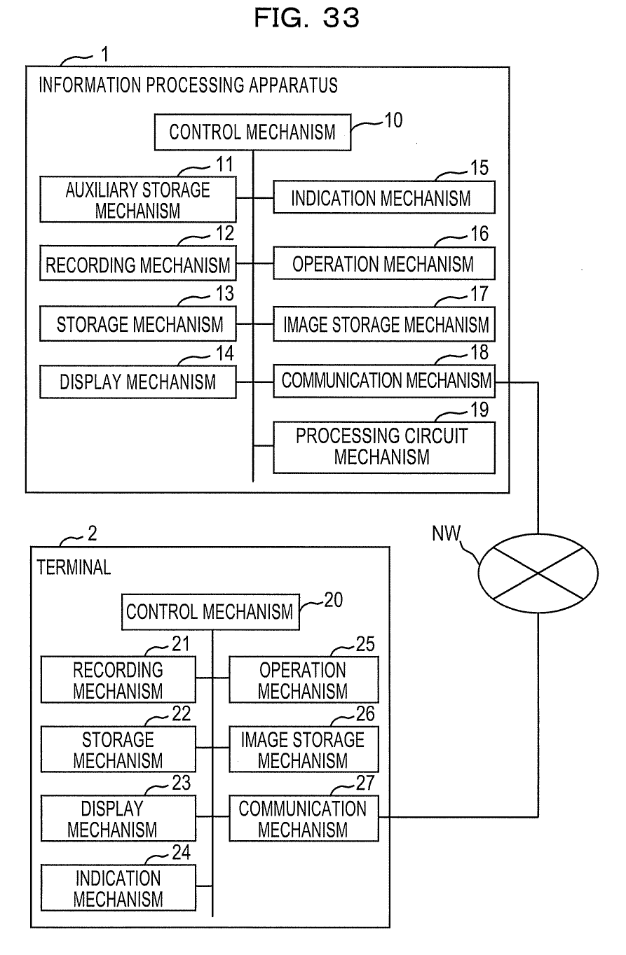

FIG. 33 is a block diagram illustrating an example of hardware of respective devices constituting the communication system according to an embodiment. An information processing apparatus 1 includes a control mechanism 10, an auxiliary storage mechanism 11, a recording mechanism 12, a storage mechanism 13, a display mechanism 14, an indication mechanism 15, an operation mechanism 16, an image storage mechanism 17, a communication mechanism 18, and a processing circuit mechanism 19 such as a chipset, a coprocessor, or the like which realizes a remote assistance system according to the present invention.

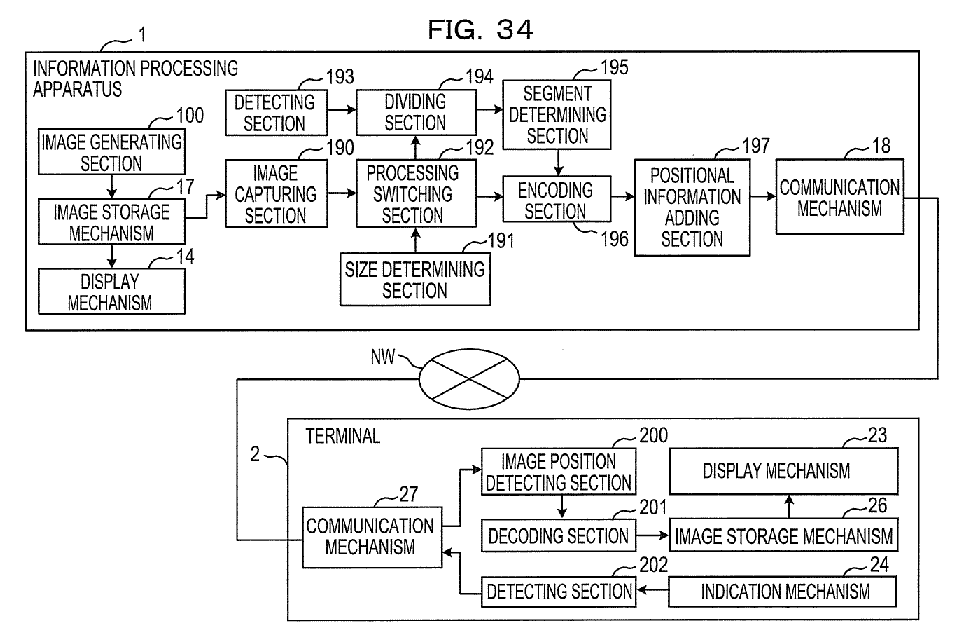

FIG. 34 is a functional block diagram illustrating an example of respective devices constituting the communication system according to an embodiment. The processing circuit mechanism 19 provided in the information processing apparatus 1 realizes functions of an image capturing section 190, a size determining section 191, a processing switching section 192, a detecting section 193, a dividing section 194, a segment determining section 195, an encoding section 196, a positional information adding section 197, and the like. The respective functions realized by the processing circuit mechanism 19 are the same as the various program modules according to an embodiment.

Since processing performed by the respective devices constituting the communication system according to an embodiment are similar to those of the above described embodiment, those descriptions shall be referenced. As illustrated, by realizing the various functions with hardware, effects such as increased processing speed can be achieved.

The embodiments described above need not necessarily be realized independently and may be realized in combinations thereof as seen fit.

In addition, the embodiments described above merely exemplify a portion of an infinite number of embodiments, and the various hardware and software can be appropriately designed depending on intended use or the like.

Furthermore, in an information processing apparatus disclosed in the present invention, a communication section is arranged so as to receive, via a communications network, status information including at least one of a status of a terminal, a status of processing performed by the terminal, and a status of communication in the communications network, and the size determining section is arranged so as to determine the size based on the processing capacity of the terminal indicated by the status information received by a receiving section. According to such a configuration, it is now possible to transmit an image from the information processing apparatus at a size not exceeding the processing capacity of the terminal or the network, and situations can be avoided where insufficient processing capacity of the terminal or the network disrupts communication.

Moreover, the information processing apparatus disclosed in the present invention further includes a control section that controls processing execution, whereby the size determining section is arranged so as to determine the size based on the load of processing controlled by the control section or on the processing capacity of the apparatus itself based on the type of the control section. According to such a configuration, it is now possible to transmit an image at a size not exceeding the processing capacity of the information processing apparatus, and situations can be avoided where insufficient processing capacity of the information processing apparatus disrupts communication.

In addition, the communication section of the information processing apparatus disclosed in the present invention is arranged so as to receive, via the communications network, indication information indicating a position on a terminal screen displayed by the terminal, whereby the information processing apparatus further includes a segment determining section that determines a segment of an image to be transmitted to the terminal based on the position indicated by the indication information received by the communication section, and the communication section transmits segment image information associated with the segment determined by the segment determining section. According to such a configuration, it is now possible to indicate, from the terminal side, a position on an image to be received from the information processing apparatus, thereby simplifying remote supporting operations from the terminal.

Furthermore, the information processing apparatus disclosed in the present invention further includes a variation judging section which, based on indication information, judges whether a position indicated by the indication information has varied or not, whereby the segment determining section is arranged to determine, when the variation judging section judges that the position has varied, a segment corresponding to the position indicated by most recently received indication information as the segment of an image to be transmitted, and when the variation judging section judges that the position has not varied, a segment that differs from the segment corresponding to the position indicated by most recently received indication information as the segment of an image to be transmitted. According to such a configuration, not only is it now possible to indicate, from the terminal side, a position on an image to be received from the information processing apparatus, the information processing apparatus automatically selects and transmits image data not yet transmitted when a position is not indicated from the terminal side. Consequently, remote supporting operations from the terminal can be further simplified.

Moreover, the segment determining section of an information processing apparatus disclosed in the present invention is arranged to repetitively determine a segment at a given time interval and fix a determined segment for a given period of time or for a given number of times. Such a configuration reduces variations in a transmission image and, in turn, reduces data volume during encoding.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An information processing apparatus, comprising:
an image generating section that generates an image to be displayed by a display section;
a size determining section that determines, based on a processing capacity of the apparatus, a size of an image to be transmitted to a terminal connected with the information processing apparatus via a communications network;
a dividing section that divides the generated image into a plurality of segments based on the size determined by the size determining section;
a positional information adding section that adds positional information indicating an on-image position of a segment divided by the dividing section to segment image information based on an image of the segment; and
a communicating section that transmits the segment image information added with the positional information to the terminal via the communications network.

2. The information processing apparatus according to claim 1, comprising a control section that controls processing execution, wherein the size determining section is arranged to determine the size based on a load of processing controlled by the control section or on the processing capacity of the apparatus based on a type of the control section.

3. An information processing apparatus, comprising:
an image generating section that generates an image to be displayed by a display section;
a size determining section that determines, based on a processing capacity of a terminal connected with the information processing apparatus via a communications network, a size of an image to be transmitted to the terminal;
a dividing section that divides the generated image into a plurality of segments based on the size determined by the size determining section;
a positional information adding section that adds positional information indicating an on-image position of a segment divided by the dividing section to segment image information based on an image of the segment; and
a communicating section that transmits the segment image information added with the positional information to the terminal via the communications network.

4. The information processing apparatus according to claim 3, wherein the communication section is arranged to receive, via the communications network, status information including at least one of a status of the terminal, a status of processing performed by the terminal, and a status of communication in the communications network, and
the size determining section is arranged to determine the size based on the processing capacity of the terminal indicated by each status information received by the receiving section.

5. The information processing apparatus according to claim 1, wherein the communication section is arranged to receive, via the communications network, indication information indicating a position on a terminal screen displayed by the terminal,
the information processing apparatus includes a segment determining section that determines a segment of an image to be transmitted to the terminal based on the position indicated by the indication information received by the communication section, and
the communication section transmits segment image information associated with the segment determined by the segment determining section.

6. The information processing apparatus according to claim 5, comprising:
a variation judging section that judges, based on the indication information, whether a position indicated by the indication information has varied or not, and
wherein the segment determining section is arranged to determine as the segment of an image to be transmitted, a segment corresponding to the position indicated by most recently received indication information when the variation judging section judges that the position has varied, and
a segment that differs from the segment corresponding to the position indicated by most recently received indication information when the variation judging section judges that the position has not varied.

7. The information processing apparatus according to claim 5, wherein the segment determining section is arranged to repetitively determine a segment at a given time interval and fix a determined segment for a given period of time or for a given number of times.

8. A computer readable recording medium storing a program that causes a computer to execute operations, comprising:
generating an image to be displayed by a display section;
determining, based on a processing capacity of a terminal connected via a communications network or a processing capacity of an apparatus, a size of an image to be transmitted to the terminal;
dividing the generated image into a plurality of segments based on the size determined by the determining;
a positional information adding section that adds positional information indicating an on-image position of a segment divided by the dividing section to segment image information based on an image of the segment; and
a communicating section that transmits the segment image information added with the positional information to the terminal via the communications network.

9. A method of causing an information processing apparatus to execute:
generating an image to be displayed;
determining, based on a processing capacity of a terminal connected via a communications network or a processing capacity of the apparatus, a size of an image to be transmitted to the terminal;
dividing the generated image into a plurality of segments based on the size determined;
adding positional information indicating an on-image position of a segment divided based on an image of the segment; and
transmitting the segment image information added with the positional information to the terminal via the communications network.

10. A communication system comprising an information processing apparatus and a terminal connected via a communications network, comprising:
the information processing apparatus including:
an image generating section that generates an image to be displayed on a screen;
a size determining section that determines, based on a processing capacity of the terminal or a processing capacity of the apparatus, a size of an image to be transmitted to the terminal;
a dividing section that divides an image displayed on the screen into a plurality of segments based on the size determined by the size determining section;
a positional information adding section that adds positional information indicating an on-screen position of a segment divided by the dividing section to segment image information based on an image of the segment; and
a communicating section that transmits the segment image information added with the positional information to the terminal via the communications network, and
the terminal including:
a communications section that receives the segment image information from the information processing apparatus; and
a terminal display section that displays an image of a segment indicated by the segment image information at a position indicated by the positional information added to the segment image information.

11. A computer implemented method of information, comprising:
dividing an image based on a processing capacity of a terminal having a first screen; and
determining a block of the image located at a position of a current indicator on a second screen and displaying only said block among the divided segments of the image via the first screen.
